(19) United States
(12) Patent Application Publication
(10) Pub. No.: US 2024/0128427 A1
(43) Pub. Date: Apr. 18, 2024

(54) SYSTEM AND METHOD FOR ELECTRODE MANUFACTURE

(71) Applicant: Rivian IP Holdings, LLC, Plymouth, MI (US)

(72) Inventors: Ki Tae Park, Santa Clara, CA (US); Hyuksang Park, San Jose, CA (US); Soo Kim, Fremont, CA (US); Meng Wang, Pleasanton, CA (US)

(21) Appl. No.: 18/047,037

(22) Filed: Oct. 17, 2022

(51) Int. Cl. H01M 4/04

(52) U.S. Cl. CPC H01M 4/0404; H01M 4/1391; H01M 2220/20

(57) ABSTRACT

At least one aspect is directed to a system. The system can include a slot die coating system to apply an electrode material to a current collector material at a coating opening. The system can further include a vacuum device to apply a vacuum pressure at the coating opening, the vacuum pressure to control application of the electrode material to the current collector material.

### INTRODUCTION

Vehicles can use electricity to power a motor. Electricity can be provided by a battery to operate the vehicle or components thereof.

### SUMMARY

A system for manufacturing an electrode (e.g., a battery electrode) can include a slot die coating system and a vacuum device. The system can include the slot die coating system to apply an electrode material (e.g., a slurry or viscous material) via a coating opening to a current collector material. The system can include the vacuum device to control the electrode material. For example, the vacuum device can include at least one vacuum chamber. The vacuum chamber can be in fluid communication with a pump via a valve. The valve can selectively allow the pump to create a vacuum pressure within the vacuum chamber. The vacuum chamber can be positioned at (e.g., proximate to, near, close to) the coating opening of the slot die coating machine. The vacuum device can apply the vacuum pressure to control the electrode material applied to the current collector material. For example, the vacuum pressure can bias (e.g., pull or draw) the electrode material in a vacuum direction as the electrode material is applied to the current collector material. The vacuum pressure can bias the electrode material in the vacuum direction to control a thickness of the electrode material applied to the current collector material. The vacuum device can operate in response to a signal provided by at least one sensor. For example, the sensor can measure a thickness of the electrode material applied to the current collector material. Based on the signal, the vacuum device can create the vacuum pressure within the vacuum chamber to control the electrode material. The vacuum device can include multiple vacuum chambers, each associated with a portion (e.g., zone, section, area) of the electrode material that is applied to the current collector material. For example, the vacuum device can create the vacuum pressure in each chamber to control respective portions of the electrode material. Each vacuum chamber can be control based on a signal from a sensor corresponding to the portion of the electrode material.

At least one aspect is directed to a system. The system can include a slot die coating system to apply an electrode material to a current collector material at a coating opening. The system can further include a vacuum device to apply a vacuum pressure at the coating opening, the vacuum pressure to control application of the electrode material on the current collector material.

At least one aspect is directed to a method. The method can include applying, by a slot-die coating system, an electrode material to a current collector material. The method can include applying by a vacuum device, a vacuum pressure to the applied electrode material to control application of the electrode material on the current collector material.

At least one aspect is directed to a control system. The control system can include a control device communicably coupled with a slot-die coating system, a valve associated with a vacuum chamber, and a sensor device. The control device can be configured to receive, from the sensor device, a signal representative of a thickness of a portion of electrode material applied by the slot-die coating system to a current collector material. The control device can be further configured to cause, based on the received signal, the valve to move from a closed position to an open position to apply, via the vacuum chamber, a vacuum pressure to the portion of the electrode material to control the thickness of the portion of the electrode material.

At least one aspect is directed to an electric vehicle. The electric vehicle can include a battery cell. The battery cell can include a plurality of electrode layers. At least one of the electrode layers can be produced by applying, by a slot-die coating system, an electrode material to a current collector material. The at least one of the electrode layers can be produced by applying by a vacuum device, a vacuum pressure to the applied electrode material to control application of the electrode material on the current collector material.

At least one aspect is directed to a method. The method can include providing a system. The system can include a slot die coating system to apply an electrode material to a current collector material at a coating opening. The system can further include a vacuum device to apply a vacuum pressure at the coating opening, the vacuum pressure to control application of the electrode material on the current collector material.

At least one aspect is directed to a method. The method can include providing a battery cell. The battery cell can include a plurality of electrode layers. At least one of the plurality of electrode layers produced by applying, by a slot-die coating system, an electrode material to a current collector material. The at least one of the plurality of electrode layers can be produced by applying by a vacuum device, a vacuum pressure to the applied electrode material to control application of the electrode material on the current collector material.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system for manufacturing an electrode, in accordance with some aspects.

FIG. 2 depicts an example system for manufacturing an electrode, in accordance with some aspects.

FIGS. 3A and 3B depict an example system for manufacturing an electrode, in accordance with some aspects.

FIG. 4 is a block diagram of an example control system for use with a system for manufacturing an electrode, in accordance with some aspects.

FIG. 5 is a flow diagram of an example method for manufacturing an electrode, in accordance with some aspects.

FIG. 6 is a flow diagram of an example method for manufacturing an electrode, in accordance with some aspects.

FIG. 7 depicts an example electric vehicle, in accordance with some aspects.

FIG. 8 depicts an example battery pack, in accordance with some aspects.

FIG. 9 depicts an example battery module, in accordance with some aspects.

FIG. 10 depicts an example cross sectional view of a battery cell, in accordance with some aspects.

FIG. 11 depicts an example cross sectional view of a battery cell, in accordance with some aspects.

FIG. 12 depicts an example cross sectional view of a battery cell, in accordance with some aspects.

FIG. 13 is a block diagram illustrating an architecture for a computer system that can be employed to implement elements of the systems and methods described and illustrated herein.

FIG. 14 is a flow diagram of an example method, in accordance with some aspects.

FIG. 15 is a flow diagram of an example method, in accordance with some aspects.

### DETAILED DESCRIPTION

Following below are more detailed descriptions of various concepts related to, and implementations of, methods, apparatuses, and systems of electrode manufacture. The various concepts introduced above and discussed in greater detail below may be implemented in any of numerous ways.

The present disclosure is directed to systems and methods of manufacturing a battery electrode. More particularly, the present disclosure is directed to systems and methods of manufacturing an electrode using an improved slot die coating process. The systems and methods can receive a current collector (e.g., copper foil, aluminum foil, carbon-coated Al foil) and can apply an electrode material (e.g., a battery-active material slurry) to the current collector as the current collector material passes through a slot-die coater system. The systems and methods can include at least one vacuum device to apply vacuum pressure proximate to a coating opening of the slot-die coater system. For example, the vacuum device can apply vacuum pressure to the current collector material and electrode material as the electrode material is applied to the current collector material via the slot-die coating system. The vacuum device can apply vacuum pressure to reduce variation of a thickness of the electrode material as applied to the current collector material.

The disclosed solutions have a technical advantage of producing a battery electrode having a reduced variation (e.g., increase uniformity) of a thickness of the electrode material in a lateral direction (e.g., a direction perpendicular to a coating direction) as applied to the current collector material. The disclosed systems and methods can reduce variation without adversely affecting yield or speed of the battery electrode manufacturing process. Furthermore, the disclosed systems and methods can allow for precision control of material thickness in a lateral direction as the electrode material is applied to the current collector material. For example, the systems and methods can include the vacuum device having at least one vacuum chamber. The vacuum chamber can apply a vacuum pressure to a portion of the electrode material applied to the current collector material via the slot-die coating system. The electrode material can be applied to the current collector material as a non-solid material, such as a slurry having high viscosity or semi-high viscosity. The vacuum chamber can apply a vacuum pressure to the electrode material to pull (e.g., draw or suck) the electrode material towards the vacuum chamber in an upstream direction. For example, the current collector material can be provided through the slot-die coating system in a first direction (e.g., an upstream direction). The vacuum chamber can apply a vacuum pressure to the electrode material to pull the electrode material in a second direction (e.g., an upstream direction) that is opposite or substantially opposite the first direction. The vacuum pressure applied to the electrode material can restrict (e.g., limit, reduce, or regulate) the amount of electrode material that is applied to the current collector material in order to control (e.g., reduce variation of or improve uniformity of) a thickness of the electrode material. While the vacuum device can apply vacuum pressure to restrict the amount of electrode material applied to the current collector material, the vacuum device can also apply a positive pressure (e.g., a pressure opposite to the vacuum pressure) to increase (e.g., assist, enhance, magnify) an amount of electrode material applied to the current collector material to control a thickness of the electrode material.

Each vacuum chamber can include a valve and can be in fluid communication with a vacuum pump. The vacuum chamber can apply vacuum pressure to a portion of the electrode material with the valve in an open or partially open position. The electrode material can be subject to ambient pressure with the valve in a closed position. The valve can open or partially open in response to a signal. For example, the vacuum device can include at least one sensor (e.g., a densimeter, laser sensor, optical sensor, or other measurement device) to measure a thickness of the electrode material applied to the current collector material. The sensor can measure a thickness of the electrode material after it is applied to the current collector material. The sensor can provide a signal representative of the measured thickness to a control system. For example, the control system can receive the signal from the sensor and can compare the signal with a threshold value to determine an extent to which the measured thickness of the electrode material varies from the threshold value. If the measured thickness of the electrode material varies from the threshold value, the control system can cause the valve associated with the vacuum chamber to open. With the valve in an open position, the vacuum chamber can apply a vacuum pressure to the electrode material to control the thickness of the electrode material.

The vacuum device can include multiple sensors, where each sensor provides a signal represented of a thickness of a portion of the electrode material (e.g., a lateral zone). Each portion of the electrode material can be associated with a vacuum chamber and that can apply a vacuum pressure to the portion of the electrode material to control a thickness of the portion of the electrode material. Each vacuum chamber can be associated with a valve that can be controlled by the control system in response to a signal from the sensor associated with the portion of the electrode material. The vacuum device can include multiple (e.g., two to one hundred or more) sensors, vacuum chambers, and valves, each associated with a portion of the electrode material and structured to control a thickness of the portion of the electrode material.

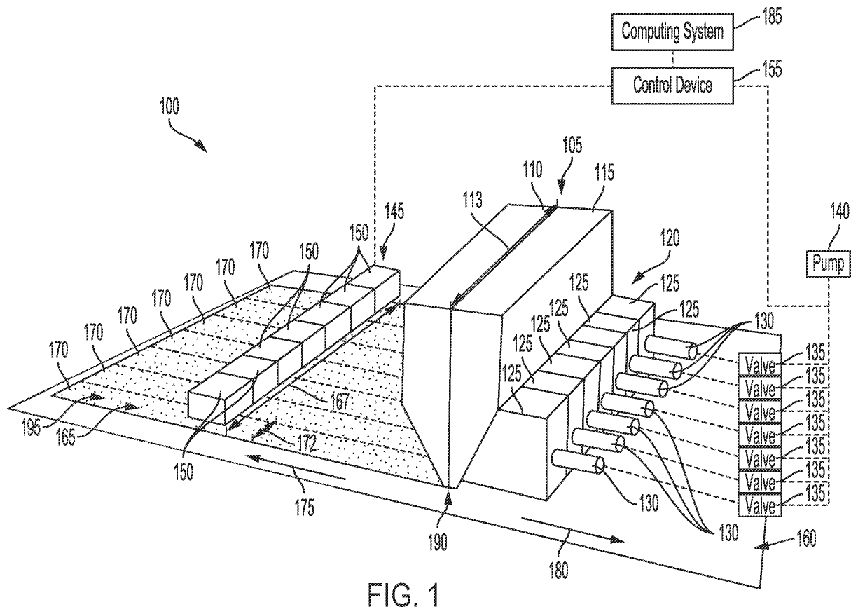

FIGS. 1-4, among others, depict a system 100 for manufacturing an electrode. For example, the system 100 can manufacture a battery electrode 195. The system 100 can include a slot die coating system 105, a vacuum device 120, a sensor device 145, a control device 155, and a computing system 185. The system 100 can manufacture a battery electrode, such as an electrode used in a lithium-ion battery or other battery. The battery electrode can be installed, along with multiple other battery electrodes, in a battery cell. The battery cell can be installed in an electric vehicle or electric storage system, for example.

The system 100 can include the slot die coating system 105 to apply an electrode material 165 to a current collector 160. For example, the system 100 can include the slot die coating system 105 to apply the electrode material 165 to the current collector material 160 at a coating opening 190 of the slot die coating system 105. The slot die coating system 105 can include a first die 110, a second die 115, a cavity 205, the coating opening 190, and a slurry pump. The slot die coating system 105 can receive the electrode material 165 in the cavity 205 and can provide the electrode material 165 between the first die 110 and the second die 115 via the coating opening 190. For example, the electrode material 165 can be a viscous material (e.g., a slurry, a liquid, a paste) that is provided via the coating opening 190. The slot die coating system 105 can apply the electrode material 165 to the current collector material 160 via the coating opening 190. The slurry pump can cause the electrode material 165 to exit the slot die coating system 105 at a particular volumetric rate. The slurry pump can be adjustable to adjust a volumetric flow rate of the electrode material 165 from the cavity 205 of the slot die coating system 105. The current collector material 160 can be metal (e.g., aluminum, copper, titanium, platinum, gold, etc.) foil, film, sheet, substrate, or other layer that is positioned proximate (e.g., near to, close to, within a predetermined distance of) the coating opening 190. The current collector material 160 can be spaced apart from the coating opening 190 by a coating gap distance 300. The electrode material 165 can exit the coating opening 190 of the slot die coating system 105 and can be applied to a first surface 210 or a second surface 215 of the current collector material 160. The slurry viscosity at 10 s⁻¹ can be ranged from 1,000 to 9,000 cPs for cathode slurry and 500 to 8,000 cPs for anode slurry. Low viscosity range is 500 to 7,000 cP, and high viscosity range is >7,000 cP.

The coating opening 190 can be a space, volume, void, gap, opening, or location at which the electrode material 165 is applied to the current collector material 160. For example, the coating opening 190 can be a gap between the first die 110 and the second die 115 that extends along a length 113 of the slot die coating system 105. The electrode material 165 can exit the slot die coating system 105 via the coating opening 190 to apply the electrode material 165 to the current collector material 160 along the entire length 113 of the slot die coating system 105. For example, the electrode material 165 can be applied to the current collector material 160 via the coating opening 190 such that the applied electrode material 165 can have a width 167 approximately equal to (e.g., ±95%) the length 113. The electrode material 165 can form a generally rectangular shape relative to the current collector material 160 after it is applied to the current collector material 160 via the slot die coating system 105. For example, the electrode material 165 can be applied to the current collector material 160 in a rectangular shape having a length approximately (e.g., ±15%) equal to a length of current collector material 160 to which the electrode material 165 is applied and a width approximately equal to the length 113 of the coating opening 190.

The slot die coating system 105 can apply multiple layers of electrode material 165 to the current collector material 160. For example, the slot die coating system 105 can include a first coating opening 190 fluidly coupled with the cavity 205 to apply a first electrode material 165 to the current collector material 160. The slot die coating system 105 can include a second coating opening 190 fluidly coupled with a second cavity 205 to apply a second electrode material 165 to the current collector material 160. For example, the slot die coating system 105 can apply the first electrode material 165 to the first surface 210 of the current collector material 160 and apply the second electrode material 165 to the first electrode material 165 to form a multiple layers of electrode material 165 applied to the current collector material 160. For example, the electrode material 165 can include two or more layers of electrode material, where each layer of electrode material can be the same as or different than at least one other layer of electrode material in terms of chemistry or some other property.

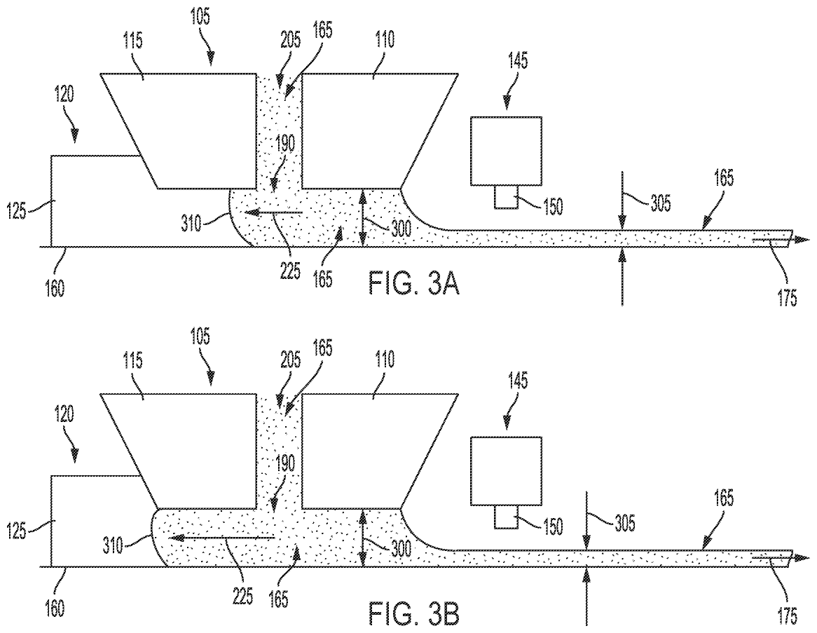

The current collector material 160 can move relative to the coating opening 190 of the slot die coating system 105. For example, the current collector material 160 can move in a first direction 175, while the slot die coating system 105 remains stationary or fixed. The current collector material 160 can remain stationary while the slot die coating system 105 moves in a second direction 180. For example, the slot die coating system 105 can be positioned adjacent the current collector material 160 such that the coating opening 190 is spaced apart from the first surface 210 of the current collector material 160, where the slot die coating system 105 can translate relative to the current collector material 160 while the coating gap distance 300 is substantially maintained (e.g., ±25% variance) between the first surface 210 of the current collector material 160. The current collector material 160 can move within a plane as the slot die coating system 105 applies the electrode material 165 to the current collector material 160. For example, the current collector material 160 can be substantially flat (e.g., ±15% unevenness or variance). As depicted in FIGS. 1 and 3A-3B, among others, the current collector material 160 can move in the first direction 175 while the current collector material is substantially flat such that the coating gap distance 300 remains substantially constant (e.g., ±15% variance). The current collector material 160 can move in a substantially flat orientation with the current collector material 160 against a conveyor surface (e.g., a conveyor substrate, conveyor belt, or similar conveyance device). The current collector material 160 can move in a substantially flat orientation with the current collector material 160 engaged with at least one web handling device. For example, the web handling device can be a roller, an idler, a wheel, a rotatable tensioner device, or some other device that can pull or move the current collector material 160 in the first direction 175. The web handling device can applying a tension to the current collector material 160 such that the current collector material 160 moves in a flat orientation in the first direction 175. The web handing device can apply a tension to the current collector material to ensure that the current collector material 160 is substantially (e.g., ±90%) free from wrinkles or slack.

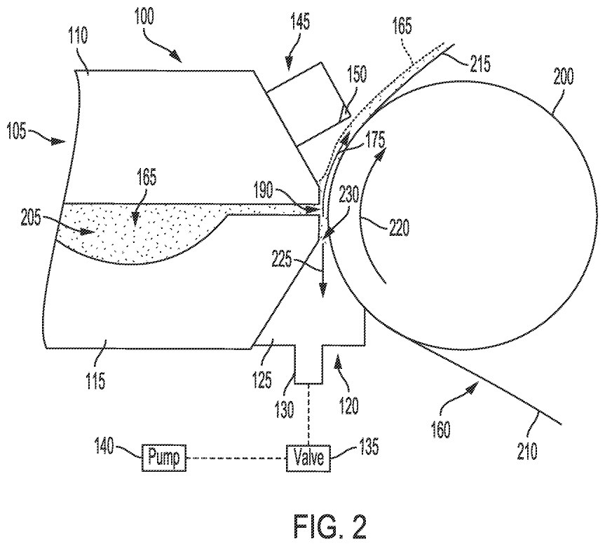

As depicted in FIG. 2, among others, the current collector material 160 can be at least partially curved or arced as the slot die coating system 105 applies the electrode material 165 to the current collector material 160. For example, the system 100 can include a roller 200. The current collector material 160 can move against (e.g., adjacent to, along, while in contact with) the roller 200. The roller 200 can be a circular roller or some other shape. The roller 200 can rotate in a roller direction 220. The roller 200 can include an outer surface that positioned near (e.g., proximate to, close to, within a predetermined distance of) the coating opening 190 of the slot die coating system 105. The current collector material 160 can move against (e.g., adjacent to, along, while in contact with) the outer surface of the roller 200. For example, the current collector 160 can move in the first direction 175 with the current collector material 160 in contact (e.g., abutting, adjacent to, against) the outer surface of the roller 200. The current collector material 160 can move in the first direction 175 that is substantially similar to (e.g., ±15%) the roller direction 220 or some other direction (e.g., tangent to the outer surface of the roller 200 at a point near the coating opening 190 or some other point).

The current collector material 160 can be spaced apart from the coating opening 190 of the slot die coating system 105 with the current collector material 160 moving against the roller 200. The current collector material 160 can be spaced apart from the coating opening 190 of the slot die coating system 105 by the coating gap distance 300 with the current collector material 160 moving against the roller 200. The current collector material 160 can contact (e.g., ride against) an arcuate portion of the roller 200 such that current collector material 160 converges towards the coating opening 190 as it approaches the slot die coating system 105 or diverges from the coating opening 190 as the current collector material 160 that has been coated with electrode material 165 moves away from the slot die coating system 105. The current collector material 160 can move in a direction that is substantially flat such that a direction in which the current collector material 160 approaches the slot die coating system 105 is substantially similar to (e.g., ±95% similar) to the direction in which the current collector moves away from the slot die coating system 105. For example, the current collector material 160 can contact the outer surface of the roller 200 at a discrete point (e.g., not an arcuate portion) of the outer surface of the roller 200.

The coating gap distance 300 can be variable. For example, the system 100 can include the roller 200 that is adjustable with respect to the coating opening 190 of the slot die coating system 105 such that the coating gap distance 300 can be adjusted. For example, the roller 200 can rotate in the roller direction 220 about an axis that is parallel to the coating opening 190 (e.g., in examples where the coating opening 190 is a line extending the length 113 of the slot die coating system 105). The roller 200 can be moveable with respect to the coating opening 190 such that the coating gap distance 300 can be increased or decreased while the axis about which the roller 200 rotates remains substantially parallel (e.g., ±10° from parallel) with the coating opening 190 as herein described. The axis about which the roller 200 rotates can be adjustable with respect to the coating opening 190. For example, the axis about which the roller 200 rotates can be made nonparallel with the coating opening 190 such that the roller 200 is closer to the coating opening 190 at one end of the roller 200 and further from the coating opening 190 at another end of the roller 200. As the roller 200 moves closer to or farther from the coating opening 190, the coating gap distance 300 can be varied for a portion of the coating opening 190 or along the entire coating opening 190 that substantially extends along the length 113.

The system 100 can include the slot die coating system 105 to apply the electrode material 165 to the current collector material 160 with the electrode material 165 having at least one portion 170. For example, the electrode material 165 that is applied to the current collector material 160 can include multiple portions 170. The electrode material 165 that is applied to the current collector material 160 can extend for the width 167, where the electrode material 165 can include multiple portions 170, with each portion 170 having a portion width 172 that is less than the width 167. The electrode material 165 can be subdivided into multiple portions 170. Each portion 170 can include an identical width or can include various widths. The electrode material 165 can include two or more portions 170. For example, the electrode material 165 can include ten portions 170, forty portions 170, one hundred portions 170, or more than one hundred portions 170.

Each portion 170 of the electrode material 165 can correspond to a portion of the coating opening 190. For example, the coating opening 190 can extend for the length 113. The slot die coating system 105 can apply the electrode material 165 to the current collector material 160 substantially (e.g., ±95%) along the entire length 113 of the coating opening 190. Each portion 170 of the electrode material 165 can be applied to the current collector material 160 by the slot die coating system 105 via a portion of the coating opening 190. For example, each portion 170 of the electrode material 165 can be applied to the current collector material 160 via an associated portion of the coating opening 190.

The system 100 can include a vacuum device. For example, the system 100 can include a vacuum device 120 including at least one vacuum chamber 125, at least one valve 135, and at least one pump 140. The system can include the vacuum device 120 to apply a vacuum pressure to the electrode material 165. For example, vacuum device 120 can apply a vacuum pressure (e.g., pressure lower than an ambient pressure, pressure lower than some other pressure) to the electrode material 165 that has been applied to the current collector material 160 by the slot die coating system 105. The system 100 can include the vacuum device 120 to apply the vacuum pressure at the coating opening 190. The system 100 can include the vacuum device 120 to apply the vacuum pressure at the coating opening 190 to expose the electrode material 165 applied to the current collector material 160 via the coating opening 190 of the slot die coating system 105 to the vacuum pressure.

The system 100 can include the vacuum device 120 including a vacuum chamber 125. The vacuum chamber 125 can be a chamber, such as an enclosed or partially enclosed cavity or space. The vacuum chamber 125 can include a plurality of walls that collectively enclose a space. The walls of the vacuum chamber 125 can be sufficiently rigid or non-deformable as to withstand vacuum pressure (e.g., negative pressure) without deforming, collapsing, or otherwise changing shape. The vacuum chamber 125 can include or be coupled with at least one conduit 130. The conduit 130 can facilitate fluid coupling of the vacuum chamber 125 with some other device (e.g., a valve, a pump, a fluid conduit, a hose, a vacuum pressure-resistant tube, or other device to facilitate the movement of fluid). The conduit 130 can fluidly couple the vacuum chamber 125 to the valve 135 or pump 140 of the vacuum device 120. For example, the conduit 130 can facilitate the creation of the vacuum pressure within the vacuum chamber 125 (e.g., within the space enclosed by the walls of the vacuum chamber 125) by fluidly coupling the pump 140 with the vacuum chamber 125.

The vacuum chamber 125 can be positioned at (e.g., proximate to, near to, close to, adjacent to, within 1-50 mm of, or directly contacting) the slot die coating system 105. For example, the vacuum chamber 125 can be positioned adjacent the second die 115 of the slot die coating system 105. The slot die coating system 105 can apply the electrode material 165 to the current collector material 160 as the current collector material 160 moves relative to the slot die coating system 105 in the first direction 175 or rotates about the roller 200 in the roller direction 220. The first direction 175 or the roller direction 220 can be a direction from the second die 115 to the first die 110. For example, the current collector material 160 that is closer to the first die 110 than the second die 115 can be coated with the electrode material 165, while the current collector material 160 closer to the second die 115 than the first die 110 can be uncoated (e.g., not yet coated with the electrode material 165 by the slot die coating system 105). The vacuum chamber 125 can be positioned in a second direction 180 or some other direction relative to the coating opening 190 that is at least partially opposed to the first direction 175. For example, the vacuum chamber 125 can be positioned relative to the coating opening 190 in the second direction 180 that is diametrically opposed to the first direction 175 or different than the first direction 175. The vacuum chamber 125 can be configured to create or maintain the vacuum pressure in a position behind the coating opening 190 relative to the direction in which the current collector material 160 moves relative to the coating opening 190.

The system 100 can include the vacuum chamber 125 having at least one opening. For example, the vacuum chamber 125 can include an opening 230 positioned at (e.g., proximate to, near to, close to, adjacent to, within 1-50 mm of, or directly contacting) the coating opening 190. The opening 230 can apply vacuum pressure (or some other pressure within the vacuum chamber 125) to the coating opening 190. For example, a vacuum pressure within the vacuum chamber 125 can cause objects or material (e.g., the electrode material 165) proximate to (e.g., near to, close to, within 0-100 mm of) the opening 230 to be drawn towards or into the vacuum chamber 125. The opening 230 can cause the vacuum pressure within the vacuum chamber 125 to act in a particular direction. For example, the opening 230 can cause the vacuum pressure to act in a vacuum direction 225. The vacuum direction 225 can be a direction in which an object (e.g., electrode material 165) is drawn (e.g., pulled). For example, the opening 230 of the vacuum chamber 125 can cause the vacuum pressure within the vacuum chamber 125 to pull or draw the electrode material in the vacuum direction 225. The vacuum direction 225 can be the same as the second direction 180. The vacuum direction 225 can be different than the second direction 180. The vacuum direction 225 can be substantially opposite (e.g., ±95% opposite) the first direction 175 or a direction in which the current collector material 160 moves relative to the slot die coating system 105.

The system 100 can include the vacuum device 120 including multiple vacuum chambers 125, where each vacuum chamber 125 can be associated with a portion 170 of the electrode material 165. For example, each vacuum chamber 125 can be positioned at (e.g., proximate to, near to, close to, adjacent to, within 1-50 mm of, or directly contacting) the coating opening 190 along a portion of the length 113 of the slot die coating system 105. Each vacuum chamber 125 can be positioned at a portion of the coating opening 190 (e.g., a subsection of the coating opening 190 associated with a portion 170 of the electrode material 165 applied to the current collector material 160). Each vacuum chamber 125 can include an opening 230 that can be positioned at the portion of the coating opening 190 and can be structured to cause the vacuum pressure to act in the vacuum direction 225. A shape or structure of the opening 230 can be the same or different for each vacuum chamber 125. The vacuum direction 225 can be the same or different for each vacuum chamber 125. For example, each of the vacuum chambers 125 can be positioned at a portion of the coating opening 190 and can cause the vacuum pressure to act in the same vacuum direction 225, where the vacuum pressure acting in the vacuum direction 225 can cause the electrode material 165 applied to the current collector material 160 to be moved (e.g., modulated, pulled, drawn, stretched) in the vacuum direction 225. The vacuum direction 225 for each of the multiple vacuum chambers 125 can be substantially opposite the first direction 175 or a direction in which the current collector material 160 moves relative to the slot die coating system 105.

The system 100 can include a pump 140. For example, the system 100 can include the pump 140 to create the vacuum pressure within the vacuum chamber 125. The pump 140 can be in fluid communication with the valve 135. The pump 140 can be in fluid communication with the vacuum chamber 125 via the valve 135 or the conduit 130. The pump 140 can create the vacuum pressure within the vacuum chamber 125 with the valve 135 in an open position. For example, the pump 140 can be fluidly coupled with the vacuum chamber 125 with the valve 135 in the open position such that the vacuum chamber 125 can be under (e.g., subjected to) the vacuum pressure. The pump 140 can be a pneumatic pump. For example, the pump 140 can be a diaphragm pump, a double-acting piston pump, a rotary vane pump, or some other type of vacuum pump. The pump 140 can generate a relative vacuum within the vacuum chamber 125. For example, the pump 140 can create a pressure within the vacuum chamber 125 that is lower than an ambient pressure. The pressure inside the vacuum chamber 125 can be a low pressure relative to an ambient pressure. The pressure within the vacuum chamber 125 as created by the pump 140 can cause an object (e.g., the electrode material 165) to move towards the vacuum chamber 125.

The system 100 can include the vacuum device 120 including at least one valve 135. For example, the system 100 can include a valve 135 to control the flow of a fluid (e.g., gas, vacuum pressure, pressurized air, or some other fluid). The valve 135 can be in fluid communication with the vacuum chamber 125. The valve 135 can be in fluid communication with the pump 140. The pump 140 can create the vacuum pressure. The valve 135 can selectively fluidly couple the pump 140 with the vacuum chamber 125 to apply the vacuum pressure within the vacuum chamber 125. The valve 135 can selectively allow a fluid (e.g., gas, vacuum pressure, pressurized air, or some other fluid) to pass from the pump 140 to the vacuum chamber 125 or vice versa.

The valve 135 can include an open position and a closed position, where the fluid can pass from the pump 140 to the vacuum chamber 125 or vice versa with the valve in the open position. For example, the valve 135 can include an actuating mechanism (a disc, a spool, a plunger, a plug, or other mechanism) that can move between an open position and a closed position. Fluid (e.g., air, vacuum pressure, pressurized air) can flow from the pump 140 to the vacuum chamber 125 via the valve 135 with the actuating mechanism in the open position. The actuating mechanism can be electronically controlled such that the actuating mechanism can move from the open position to the closed position or from the closed position to the open position in response to an electrical signal. For example, the actuating mechanism can move from the closed position to the open position in response to a signal or command from some other device. The valve 135 can be an electromagnetically-operated valve where the actuating mechanism can move from the closed position to the open position via an electromagnetic force created in response to an electrical signal (e.g., a magnetic field created by electrifying a coil of wire). The valve 135 can be normally closed. For example, the valve 135 can be in a closed position in absence of any other forces (e.g., an electromagnetic force). The actuating mechanism can be spring-biased. For example, a spring of the valve 135 can apply a spring force to the actuating mechanism to move the actuating mechanism from the open position to the closed position or to retain the actuating mechanism in the closed position until a force (e.g., an electromagnetic force) is applied to overcome the biasing spring force.

The valve 135 can vary a vacuum pressure applied to a vacuum chamber 125 by the pump 140. For example, a weaker vacuum pressure can be applied to the vacuum chamber 125 via the pump 140 with the actuating member of the valve 135 in a partially open position (e.g., some intermediate position between the closed position and the open position) than when the actuating member of the valve 135 is in a fully open position. The vacuum pressure applied to the vacuum chamber 125 and correspondingly applied at the coating opening 190 can be directly or indirectly related to a degree to which the valve 135 is open or closed. For example, the vacuum pressure can be dynamic based on a position of actuating member of the valve 135 between a fully closed position and a fully open position. The actuating member of the valve 135 can be electronically controlled and can be automatically moved (e.g., electronically moved in response to some signal or command) to a partially open position or a fully open position. For example, the actuating member of the valve 135 can move to a particular position (e.g., a partially open position) in response to a command or signal. The actuating member of the valve 135 can move to a particular open position in response to a signal representative of a pressure within the vacuum chamber 125. For example, the vacuum chamber 125 can include a pressure sensor to measure a pressure within the vacuum chamber 125. The actuating member of the valve 135 can move towards a fully open position or towards a fully closed position until a desired pressure within the vacuum chamber 125 is attained. For example, the valve 135 can automatically adjust a position of the actuating member of the valve 135 based on the measured pressure within the vacuum chamber 125 to achieve or maintain a desired vacuum pressure within the vacuum chamber 125.

The system 100 can include multiple valves 135. For example, the system 100 can include at least one valve 135 per vacuum chamber 125. The system 100 can include at least one valve 135 per portion 170 of the electrode material 165 applied the current collector material 160. For example, system 100 can include two valves 135 and two vacuum chambers 125 in examples where the electrode material 165 includes two portions. The system 100 can include one hundred valves 135 and one hundred vacuum chambers 125 in examples where the electrode material 165 is subdivided into one hundred portions 170, for example. Each of the multiple valves 135 can be associated with a single vacuum chamber 125, which can be associated with a single portion 170 of the electrode material 165. The valve 135 can selectively apply the vacuum pressure to the vacuum chamber 125 associated with the portion 170 of the electrode material 165. The valve 135 can selective apply the vacuum pressure at the portion of the coating opening 190 associated with the portion 170 of the electrode material 165 to control the portion 170 of the electrode material 165 applied to the current collector material 160. For example, the actuating mechanism of the valve 135 can move from a closed position to an open position to fluidly couple the vacuum chamber 125 associated with the portion 170 of the electrode material with the pump 140 (or with a single pump 140 of multiple pumps 140, or with multiple pumps simultaneously) such that the pump 140 can apply the vacuum pressure to the portion of the coating opening 190 associated with the portion 170 of the electrode material 165 applied to the current collector material 160. Each of the multiple valves 135 can be controlled (e.g., actuated from a closed position to an open position) independently of other valves 135. For example, the vacuum pressure can be applied to each portion 170 of the electrode material 165 via a vacuum chamber 125 associated with the valve 135 independently.

The system 100 can include one pump 140 to provide the vacuum pressure to multiple vacuum chambers 125. For example, the vacuum device 120 can include a single pump 140 that is in fluid communication with each of multiple vacuum chambers 125. The pump 140 can include one or more fluid conduits (e.g., hoses, tubes, pipes) in fluid connection with the conduit 130 of each of the plurality of vacuum chambers 125. When the pump 140 operates to create the vacuum pressure, the pump 140 can create a vacuum pressure within each of the vacuum chambers 125 simultaneously. The pump 140 can provide the vacuum pressure to whichever of the multiple vacuum chambers 125 is associated with a valve 135 that is in the open position. For example, the vacuum device 120 can include multiple valves 135 associated with each of the multiple vacuum chambers 125, where at least one of the valves 135 is in an open position as to allow the pump to apply the vacuum pressure to at least one vacuum chamber 125 and at least one of the valves 135 is in the closed position as to fluidly decouple at least one vacuum chamber 125 from the pump 140. The system 100 can include multiple pumps 140 to apply the vacuum pressure to multiple vacuum chambers 125. For example, each of multiple vacuum chambers 125 can be associated with an individual vacuum pump 140 of multiple vacuum pumps 140 such that each pump 140 can apply the vacuum pressure to a single vacuum chamber 125. The system 100 can include multiple pumps 140, where each pump 140 is associated with one or more vacuum chambers 125, but fewer than all vacuum chambers 125.

The pump 140 can provide the vacuum pressure to whichever of the vacuum chambers 125 are fluidly coupled with the pump 140 by virtue of a valve 135 associated with the vacuum chambers 125 being in an open position. The pump 140 can create an identical vacuum pressure in each of the vacuum chambers 125. The vacuum pressure can be affected by the number of vacuum chambers 125 in fluid communication with the pump 140. For example, if the vacuum device 120 includes multiple vacuum chambers 125, each associated with multiple valves 135, but only a single valve 135 is in an open position to fluidly couple the pump 140 to a single vacuum chamber 125, the vacuum pressure can be higher than when the pump 140 is simultaneously fluidly coupled with each of the multiple vacuum chambers 125 and applying the vacuum pressure to each. The pump 140 can apply a variable vacuum pressure to a chamber 125 based on a total volume (e.g., the sum of volumes of each vacuum chamber 125 that is fluidly coupled with the pump 140) to which the vacuum pressure is applied. For example, the greater the volume to which the pump 140 is applying the vacuum pressure, the weaker the vacuum pressure. The pump 140 can be configured to apply a consistent vacuum pressure to each vacuum chamber 125 regardless of a total volume to which the vacuum pressure is applied. For example, the pump 140 can be a variable displacement pump that can maintain a particular vacuum pressure for a range of displaced volumes, including volumes associated with one or all of the vacuum chambers 125.

The system 100 can include a vacuum device 120 to apply a vacuum pressure at the coating opening 190. For example, the vacuum device 120 can apply the vacuum pressure at the coating opening 190 via the opening 230 of the vacuum chamber 125. The vacuum device 120 can include the pump 140 to apply the vacuum pressure to the vacuum chamber 125, where the vacuum chamber 125 includes an opening 230 positioned at (e.g., proximate to, near to, close to, adjacent to, within 1-50 mm of, or directly contacting) the coating opening 190. The opening 230 can cause the vacuum pressure to act in the vacuum direction 225 with the vacuum pressure applied to the vacuum chamber 125. For example, the opening 230 can be positioned relative to the coating opening 190 to cause the vacuum pressure to pull (e.g., draw) an object (e.g., the electrode material 165) in the vacuum direction 225. The vacuum direction 225 can be opposite the first direction 175 or a direction in which the current collector material 160 moves relative to the slot die coating system 105. The opening 230 can positioned relative to the coating opening 190 such that the viscous (e.g., soft, wet, uncured) electrode material 165 that is applied to the current collector material 160 by the slot die coating system 105 at the coating opening 190 can be drawn or pulled in the vacuum direction 225 with the vacuum pressure applied to the vacuum chamber 125. The electrode material 165 applied to the current collector material 160 can be pulled or drawn in the vacuum direction 225 where the vacuum direction 225 is opposite the first direction or the direction in which the current collector material 160 moves relative to the slot die coating system 105.

The system 100 can include the vacuum device 120 to apply a vacuum pressure to control the electrode material 165. For example, the system 100 can include the vacuum device 120 to apply a vacuum pressure at the coating opening 190 to control (e.g., modulate, affect, influence, modify, manipulate, move) the electrode material 165 applied to the current collector material 160. The electrode material 165 can be a viscous material that is soft, malleable, deformable, or moveable as the electrode material 165 is applied to the current collector material 160. For example, the slot die coating system 105 can apply the viscous electrode material 165 to the current collector material 160 with the electrode material 165 in an uncured or wet (e.g., not dried, hardened, or solidified) form such that the electrode material 165 can be (at least temporarily) viscous after it is applied to the current collector material 160. The electrode material 165 can be remain uncured or wet for an amount of time after the electrode material 165 is provided to the current collector material 160 via the coating opening 190 of the slot die coating system 105. The electrode material 165 can be applied to the current collector material 160 with an initial material thickness. For example, the electrode material 165 can be provided by the slot die coating system 105 to the current collector material 160 at a predefined rate such that a predefined amount of electrode material 165 is provided over an area of current collector material 160 such that the electrode material 165 has a particular material thickness.

The electrode material 165 can be controlled (e.g., modulated, affected, influenced, modified, manipulated, moved) by the vacuum device 120. For example, the electrode material 165 can be controlled (e.g., modulated, affected, influenced, modified, manipulated, moved) by the vacuum pressure applied at the coating opening 190 via the vacuum chamber 125. With the electrode material 165 in an uncured or wet state, the electrode material 165 can be controlled by the vacuum pressure applied by the vacuum device 120. For example, the electrode material 165 can be pulled (e.g., drawn, moved, tugged, stretched, or modulated) in a direction or directions of the applied vacuum pressure. For example, the vacuum device 120 can apply the vacuum pressure pull the electrode material in the vacuum direction 225, where the vacuum direction 225 can be the same as or different than the second direction 180. The vacuum chamber 125 can include the opening 230 positioned at (e.g., proximate to, near to, close to, adjacent to, within 1-50 mm of, or directly contacting) the coating opening 190 such that uncured or wet electrode material 165 that exits the slot die coating system 105 via the coating opening 190 can be exposed to (e.g., be influenced by, be subject to) the vacuum pressure. For example, the vacuum chamber 125 can be positioned relative to the second die 115 of the slot die coating system 105 such that the opening 230 can cause the electrode material 165 to move from the first die 110 towards the second die 115.

The system 100 can include the current collector material 160 to move in the first direction 175 relative to the slot die 105 coating system with the vacuum device 120 to apply the vacuum pressure to pull the electrode material 165 in the vacuum direction 225. For example, the system 100 can include the vacuum device 120 to apply the vacuum pressure to pull the electrode material 165 in the vacuum direction 225 as the current collector material advances in the first direction 175. As depicted in FIGS. 2 and 3A-3B, among others, the vacuum device 120 can cause the electrode material 165 to move in the vacuum direction 225, where the vacuum direction 225 is opposite the first direction 175 or a direction in which the current collector material 160 moves relative to the coating opening 190. The vacuum direction 225 can be diametrically opposed to the first direction 175 or can be otherwise different than the first direction 175 (e.g., 170° difference between the first direction 175 and the vacuum direction 225). For example, as depicted in FIG. 2, among others, the vacuum direction 225 can be substantially tangent (e.g., ±10° from tangent) to the outer surface of the roller 200, while the current collector material can advance along an arcuate path on the outer surface of the roller 200 in the roller direction 220 such that the direction in which the current collector material 160 advances is not diametrically opposed to the vacuum direction 225.

The system 100 can include the vacuum device 120 to control the electrode material 165 applied to the current collector material 160 by pulling or drawing the electrode material 165 in the vacuum direction 225 to control (e.g., reduce, meter, limit, modulate, modify, constrain) an amount of electrode material 165 that is applied to a particular portion of the current collector material 160. For example, the current collector material 160 can move at a predefined rate relative to the coating opening 190 of the slot die coating system 105, and the slot die coating system 105 can apply electrode material 165 to the current collector material 160 at a predefined rate. The amount of electrode material 165 applied to the current collector material 160 can be reduced (e.g., reduced by 1-5%, 5-15%, or greater than 15%) with the vacuum device 120 applying the vacuum pressure to the electrode material 165 via the vacuum chamber 125. For example, the vacuum device 120 can apply the vacuum pressure via the vacuum chamber 125 to the electrode material 165 applied to the current collector material 160 to pull or draw the electrode material 165 in the vacuum direction 225 as the current collector material 160 advances in the first direction at a predefined rate and as the slot die coating system 105 provides the electrode material 165 via the coating opening 190 at a predefined rate. The amount or volume of electrode material 165 that advances with the current collector material 160 can be reduced with the vacuum pressure acting on the electrode material 165 in the vacuum direction 225. For example, the vacuum pressure can act to prevent or substantially prevent (e.g., ±85%) a portion of the electrode material 165 from advancing along with the current collector material 160 in the first direction 175.

The system 100 can include the vacuum device 120 to apply the vacuum pressure to control a thickness 305 of the electrode material 165 that has been applied to the current collector material 160. The electrode material 165 can be applied to the current collector material 160 by the slot die coating system 105 at a predefined rate as the current collector material 160 advances in the first direction at a predefined rate, thereby causing the electrode material 165 to be applied to the current collector material 160 with a resultant material thickness 305. The vacuum device 120 can act on the electrode material 165 applied to the current collector material 160 to reduce the thickness 305. For example, the amount of electrode material 165 that advances along with the current collector material 160 can be reduced with the vacuum pressure acting on the electrode material 165, thereby causing a reduction in thickness 305 of the electrode material 165. The vacuum pressure can pull (e.g., draw) the electrode material 165 in the vacuum direction 225 as the current collector material 160 advances in the first direction 175 relative to the slot die coating system 105. The vacuum device 120 can reduce (e.g., limit, constrain, curtail, decrease, moderate, modulate) the amount of electrode material 165 that advances in the first direction 175 with the current collector material 160 by pulling or drawing a portion of the electrode material 165 in the vacuum direction. By reducing the amount of electrode material 165 that advances in the first direction 175 along with the current collector material 160 while the current collector material 160 advances in the first direction at a predefined rate, the vacuum device 120 can reduce a thickness 305 of the electrode material 165.

The system 100 can include the vacuum device 120 to move a meniscus 310 of the electrode material 165 in the vacuum direction 225. For example, the vacuum device 120 can apply the vacuum pressure at the coating opening 190 to control (e.g., affect, manipulate, restrict, modulate) the electrode material 165 that has exited the slot die coating system 105 via the coating opening 190. The meniscus 310 can form between the second die 115 and the current collector material 160 as the electrode material 165 exits the slot die coating system 105 via the coating opening 190. As the current collector material 160 moves in the first direction 175, the meniscus can be positioned proximate to (e.g., close to, near to, within 1-50 mm of, within 50-100 mm of) the coating opening 190. For example, the movement of the current collector material 160 relative to the slot die coating system 105 in the first direction 175 can create a shearing force that acts on the electrode material 165 and draws the electrode material 165 in the first direction while a pressure differential between the cavity 205 of the slot die coating system 105 and an ambient environment acts to pull the electrode material at least partially in a direction opposite the first direction 175. The meniscus 310 can be positioned proximate to (e.g., within 1-50 mm of) the coating opening 190 with the pressure differential and the shearing force in a state of equilibrium. The vacuum device 120 can apply the vacuum pressure to increase a pressure differential between the cavity 205 of the slot die coating system 105 and vacuum chamber. The pressure differential between the cavity 205 and the vacuum chamber can act to pull (e.g., draw) the electrode material 165 in the vacuum direction 225 towards the vacuum chamber. This pressure differential can act to move the meniscus 310 in the vacuum direction 225 (e.g., away from the coating opening 190 in an upstream direction).

The system 100 can include the vacuum device 120 to apply a variable vacuum pressure to the electrode material 165 to vary a thickness 305 of the electrode material 165. For example, the system 100 can include the vacuum device 120 including the pump 140 having a variable displacement whereby the pump 140 can create a variable vacuum pressure within the vacuum chamber 125. The pump 140 can create a relatively strong vacuum pressure (e.g., 1 mTorr). The pump 140 can create a relatively weak vacuum pressure (e.g., greater than 760 mTorr). For example, the pump 140 can create a vacuum pressure ranging from 0.5 mTorr to 1 Torr or a vacuum pressure greater than 1 Torr. The vacuum device 120 can pull (e.g., draw) the electrode material 165 in the vacuum direction to a varying degree based on the vacuum pressure. For example, the vacuum device 120 can pull the electrode material 165 in the vacuum direction 225 to a greater degree with a vacuum pressure of 1 mTorr (e.g., FIG. 3B) than with a vacuum pressure of 1 Torr (e.g., FIG. 3A).

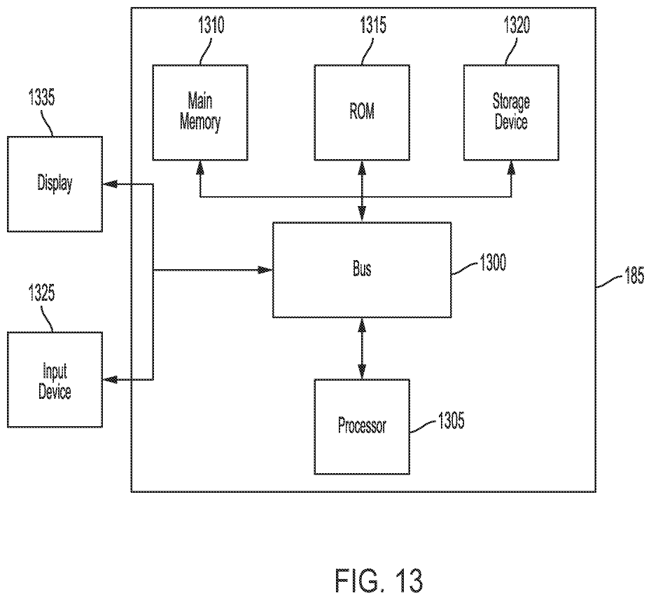

The system 100 can include a control device 155, a sensor device 145, and a computing system 185. For example, the system 100 can include a control device 155 to control an operation of the system 100. The control device 155 can be or include hardware components, software, or a combination of hardware and software. For example, the control device 155 can be a hardware controller mounted to or positioned physically near to (e.g., within 1 foot, within five feet, within ten feet) of the slot die coating device 105. The control device 155 can be the computing system 185 as depicted in FIG. 13, among others. The control device 155 can be separate from the computing system 185, but can be similar to the computing system 185 (e.g., include similar components and perform similar functions). For example, the control device 155 can include at least one processor (e.g., a processor similar to the processor 1305 discussed with reference to FIG. 13, among others) and at least one memory (e.g., similar to the memory 1310 or the memory 1315 discussed with reference to FIG. 13, among others). The processor can execute instructions stored locally on the memory or remotely to perform one or more actions. For example, the memory can include instructions (e.g., software, at least one application, programming instructions) that, when executed by the processor, cause the processor to perform one or more actions as described in greater detail below. The control device 155 can include a display device (e.g., an LCD screen, a touch screen display, or other display device). The control device 155 can include one or more input devices to receive a user's physical (e.g., tactile, manual) input. For example, the control device 155 can include or be communicably coupled with one or more buttons, knobs, switches, scroll wheels, microphones, keyboards, optical sensors, or input device. The control device 155 can be a mobile device (e.g., a handheld computer, a tablet computing device, a mobile phone, smart watch, or other device).

The control device 155 can be a software program or application that can be implemented on one or more hardware devices. For example, the control device 155 can be a web-based application that can be accessed via a personal computing device (e.g., laptop computer, mobile phone, or other device). The system 100 can include multiple control device 155. For example, the system 100 can include multiple control devices 155, where each control device 155 can influence an operation of various components (e.g., the slot die coating system 105, the vacuum device 120, or the sensor device 145) of the system 100 as described below. Multiple control devices 155 can collectively operate to control one or more operations of the system 100 and the components (e.g., the slot die coating system 105, the vacuum device 120, or the sensor device 145) of the system 100.

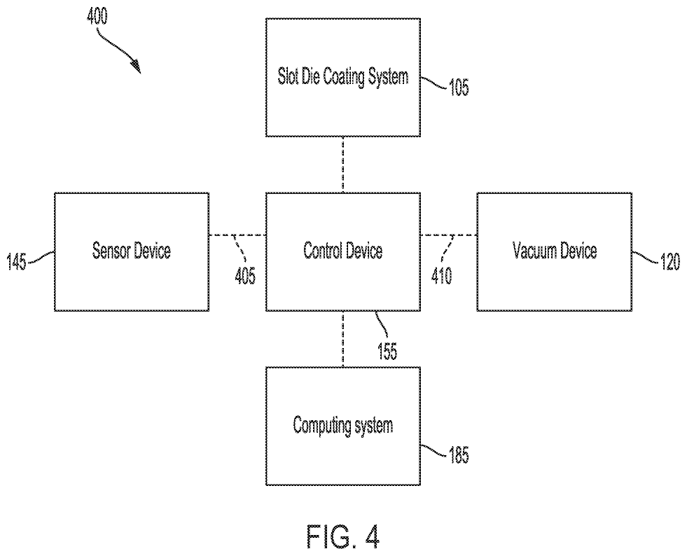

The control device 155 can control an operation of the vacuum device 120, an operation of the slot die coating system 105, or an operation of a sensor device 145. As depicted in FIG. 4, among others, the control device 155 can be wirelessly coupled with the vacuum device 120, a computer system 185, or the sensor device 145. For example, the control device 155 can communicate with the sensor device 145, the vacuum device 120, or the computing system 185 via one or more wireless communication protocols including communication over a local area network (“LAN”), a wide area network (“WAN”), an inter-network (e.g., the Internet), or a peer-to-peer network (e.g., ad hoc peer-to-peer networks). The control device 155 can communicate with the sensor device 145, the vacuum device 120, or the computing system 185 via a wired connection. The control device 155 can be a local control device positioned proximate to (e.g., physically near to, close to, or within one foot of, within five feet of, within twenty feet of) the vacuum device 120, sensor device 145, or slot die coating system 105. The control device 155 can be a remotely located control device 155 that is remote to (e.g., more than twenty feet away from) the vacuum device 120, the sensor device 145, or the slot die coating system 105.

The computing system 185 shown in FIG. 13, among others, can be a remotely-located computing system 185 that can communicate with the control device 155 via wireless communication over a network. The computing device 185 can communicate with the control device 155. For example, the computing device 185 can receive data regarding the system 100 via the control device 155 to monitor a state of the control device 155. The computing device 185 can be communicably coupled with more than one control device 155 associated with more than one system 100 (e.g., multiple systems 100 located at a manufacturing facility). The computing system 185 can provide information to the control device 155 to affect the operation of the control device 155 or the system 100 more broadly. For example, the computing system 185 can provide operating instructions, manufacturing profiles (e.g., a set of instructions prescribing particular operations), or other data relevant to the operation of the system 100 (e.g., temperature or humidity information related to an environment of the system 100). The computing system 185 can include or provide a user interface to enable a user to control or monitor the system 100. For example, the computing system 185 can provide a graphical user interface to a user via a display device (e.g., screen, LCD display, LED display, or other device). The graphical user interface can visually depict one or more parameters related to the system 100, such as a throughput rate, a state of the vacuum device 120, measurements provided by the sensor device 145, or otherwise. The computing system 185 can include on or more input devices (e.g., a keyboard, a touchscreen interface, or other device) that can receive user input. The user input can correspond to instructions or a command provided to the control device 155 that ultimately affect the operation of the system 100.

The control device 155 can receive information (e.g., a signal, data, measurements, or other information) from or transmit information to one or more of the sensor device 145, the vacuum device 120, the slot die coating system 105, or the computing system 185 at regular intervals (e.g., every thirty seconds, every minute, or every five minutes. The control device 155 can receive information (e.g., a signal, data, measurements, or other information) from or transmit information to one or more of the sensor device 145, the vacuum device 120, the slot die coating system 105, or the computing system 185 via a continuous data stream. The control device 155 can transmit a request for information from the sensor device 145, the vacuum device 120, the slot die coating system 105, or the computing system 185. For example, the control device 155 can receive information (e.g., a signal, data, measurements, or other information) to one or more of the control device 155, the vacuum device 120, the slot die coating system 105, or the computing system 185 based on a transmitted request for information from the sensor device 145, the vacuum device 120, slot die coating system 105, or the computing device 185. For example, the control device 155 may transmit a request for information from the sensor device 145, the vacuum device 120, the slot die coating system 105, or the computing system 185 periodically or upon occurrence of some event (e.g., application of vacuum pressure at the coating opening 190). The control device 155 can provide information (e.g., a signal, a command, data, or other information) to the sensor device 145, the vacuum device 120, the slot die coating system 105, or the computing system 185. For example, the control device 155 can provide a command to the sensor device 145, the vacuum device 120, the slot die coating system 105, or the computing device 185, where the command can cause the sensor device 145, the vacuum device 120, the slot die coating system 105, or the computing device 185 to perform some operation, change an operational state, or provide some information to the control device 155 or otherwise.

The system 100 can include the sensor device 145 to provide information to a control device 155. The system 100 can include the sensor device 145 to provide a signal representative of a parameter regarding the electrode material 165. For example, the system 100 can include the sensor device 145 to measure a parameter of the electrode material 165 that has been applied to the current collector material 160. The sensor device 145 provide (e.g., transmit, send, communicate) a signal representative of a measured parameter of the electrode material 165 to the control device 155, to the vacuum device 120, or to a computing system 185. For example, the sensor device 145 can periodically transmit (e.g., at a regular interval such as every second, every five seconds, every minute, or otherwise) or continuously transmit (e.g., a continuous data stream) a signal representative of a measured parameter to the control device 155. The control device 155 can use the signal representative of the measured parameter of the electrode material 165 to affect the operation of the system 100, as is discussed in detail below.

The sensor device 145 can include at least one sensor 150. For example, the sensor device 145 can include multiple sensors 150, where each sensor 150 can be associated with a portion 170 of the electrode material 165. The sensor 150 can be a densimeter (e.g., a density meter), an optical sensor, an ultrasonic proximity sensor, an inductive sensor, or some other sensor. For example, the sensor device 145 can include at least one sensor 150 per portion 170 of the electrode material 165, where the sensor 150 is a densimeter sensor configured to measure a mass of electrode material 165 applied to the current collector material 160 or a thickness 305 of the electrode material 165 applied to the current collector material 160. The densimeter can be a beta ray sensor, a photon sensor, an x-ray sensor, or an ultrasonic sensor. For example, the densimeter can measure an amount (e.g., mass) of electrode material 165 applied to an area of the current collector material 160. The sensor device 145 can include a sensor 150 for each portion 170 of the electrode material 165, where the sensor 150 can measure a parameter of some or all of the portion 170. For example, the sensor 150 can measure a parameter representative of a thickness 305 of the electrode material 165 for the entire width of 172 of a portion 170. The sensor 150 can measure a parameter representative of a thickness 305 of the portion 170 over a distance that is less than the width 172 of the portion 170. The sensor 150 can measure some other parameter of the portion 170 of the electrode material 165, such as a volume of the portion 170 of the electrode material 165, a cross-sectional area of the portion 170 of the electrode material 165, a density of the portion 170 of the electrode material 165 per unit volume, a density of the portion 170 of the electrode material 165 per unit area, or some other parameter associated with the portion 170 of the electrode material 165.

The system 100 can be or include a control system 400. As depicted in FIG. 4, among others, the control system 400 can include the slot die coating system 105, the control device 155, the vacuum device 120, the sensor device 145, and the computing system 185, where each of the slot die coating system 105, the vacuum device 120, the sensor device 145, and the computing system 185 are communicably coupled with the control device 155. The control system 400 can include the sensor device 145 to provide a signal 405 to the control device 155 that includes information representative of at least one measured parameter of at least one portion 170 of the electrode material 165. For example, the sensor device 145 can send the signal 405 (e.g., data) to the control device 155, where the signal includes information representative of a measured parameter of each portion 170 of the multiple portions 170 of the electrode material 165. The signal 405 can include information or data that can allow the control device 155 to associate a particular measured parameter with a particular portion 170 of the electrode material 165. For example, the signal 405 can associate each measured parameter with a particular portion 170 such that the control device 155 can subsequently provide a command or instruction to the vacuum device 120 to apply a particular vacuum pressure to a vacuum chamber 125 associated with the particular portion 170 of the electrode material. The signal 405 can enable the control device 155 to provide a particularized command to the vacuum device 120 for each portion 170 such that the vacuum device 120 can apply a vacuum pressure at the portion of the coating opening 190 associated with the portion 170 to control the portion 170. For example, the signal 405 can be representative of a first thickness 305 associated with a first portion 170 of the electrode material 165, a second thickness 305 associated with a second portion 170 of the electrode material 165, a third thickness 305 of a third portion 170 of the electrode material 165, and so on. The sensor device 145 can provide the signal 405 to the control device 155 where the signal 405 is representative of only one measured parameter of one portion 170 of the electrode material 165. For example, the signal 405 can be representative of a first thickness 305 of a first portion 170 of the electrode material 165 while a second signal 405 can be representative of a second thickness 305 of a second portion 170 of the electrode material 165.

The system 100 can include the control device 155 to control or operate the vacuum device 120, the slot die coating system 105, the sensor device 145, or some other system or device associated with the system 100. For example, the control device 155 can cause the vacuum device 120 to operate in a particular manner. The control device 155 can cause the vacuum device 120 to create a vacuum pressure, apply the vacuum pressure at the coating opening 190 via the vacuum chamber, actuate the valve 135, increase a displacement of the pump 140, or otherwise alter an operation of the vacuum device 120. The control device 155 can cause the sensor device 145 to operate in a particular manner. For example, the control device 155 can cause the sensor device 145 to collect data (e.g., measurements associated with a parameter of the electrode material 165 applied to the current collector material) from one sensor 150, to collect data from multiple sensors, to collect data from one or more sensors at a particular frequency, to transmit a signal representative of a parameter of the electrode material 165 in a particular data format, to transmit a signal representative of a parameter of the electrode material 165 to some other device (e.g., the control device 155, an wireless computing device, or other computing device) via a particular communication protocol, or some other operation.

As depicted in FIG. 4, among others, the control device 155 can transmit a signal 410 to the vacuum device 120. For example, the control device 155 can transmit the signal 410 to cause the vacuum device 120 to operate in a particular manner, perform a particular function, or otherwise operate. The control device 155 can transmit the signal 410 to a valve 135 of the vacuum device 120. The control device 155 can transmit the signal 410 to the pump 140 of the vacuum device 120. The signal 410 can cause the valve 135 to operate in a particular manner. For example, the signal 410 can cause the actuating member of the valve 135 to move from a closed position to a partially open position or to a fully open position to fluidly couple the pump 140 with the vacuum chamber 125. The signal 410 can cause the actuating member of the valve 135 to move to a position (e.g., a partially open position) to achieve a desired vacuum pressure within the vacuum chamber 125. The signal 410 can cause the actuating member of the valve 135 to automatically move (e.g., adjust position) to maintain a desire vacuum pressure within the vacuum chamber 125 as determined by a measured pressure within the vacuum chamber. The signal 410 can cause the pump 140 to create a vacuum pressure that can be applied to any vacuum chambers 125 that are fluidly coupled with the pump 140 (e.g., those vacuum chambers 125 associated with a valve 135 that is in an open position). The signal 410 can cause the pump 140 to alter a displacement in order to increase or decrease the vacuum pressure.

The control device 155 transmit a signal (e.g., the signal 410) to the vacuum device 120, the slot die coating system 105, the sensor device 145, to cause the vacuum device 120, the sensor device 145, the slot die coating system 105, or some other system to operate in a particular manner. For example, the signal can be a command signal that, when received by the vacuum device 120, sensor device 145, slot die coating system 105, or other device can prompt the respective device or system to perform a certain operation or operate (or cease operating) in a particular manner. For example, the system 100 can include the control device 155 to transmit a signal to the slot die coating system 105 to cause the slot die coating system 105 to alter a volumetric flow rate of the electrode material 165 from the coating opening 190. The control device 155 can transmit a signal to the computing device 185 requesting information regarding an environmental parameter (e.g., a humidity of a manufacturing area). The control device 155 can transmit a signal to the sensor device 145 to prompt the sensor device 145 to transmit a new signal 405 representative of an updated measured parameter of a portion 170 of the electrode material 165. For example, the control device 155 can prompt the sensor device 145 to provide a signal representative of a thickness 305 of the electrode material 165 reflecting a change to an operation of the vacuum device 120 (e.g., a thickness measurement post-application of the vacuum pressure).

The system 100 can include the valve 135 to move from a closed position to the open position based on a command from the control device 155. For example, the control device 155 can transmit a signal (e.g., the signal 410) to the vacuum device 120 to cause the vacuum device 120 to apply the vacuum pressure at the coating opening 190 to control the electrode material 165 applied to the current collector material 160. The signal 410 can cause the valve 135 to move from a closed position to an open position or from a first position (e.g., a mostly-closed position) to a second position (e.g., a mostly-open position). For example, the valve 135 can be an automatic or semi-automatic electronically controlled valve that can cause the actuating member of the valve 135 to move from one position to another position in response to a signal, such as the signal 410. The signal 410 can include an instruction to maintain a particular pressure within a vacuum chamber 125 associated with the valve 135. For example, the valve 135 can automatically adjust a position between the open position and the closed position to maintain a desired pressure within the vacuum chamber 125 based on a pressure measurement from a pressure sensor within the vacuum chamber 125.

The system 100 can include the control device 155 to cause the vacuum device 120 to apply the vacuum pressure within a predetermined amount of time. For example, the system 100 can include the control device 155 to cause the vacuum device 120 to apply the vacuum pressure at the coating opening 190 less than one second after the sensor device 145 measures a parameter of the electrode material 165. The sensor device 145 can promptly (e.g., within 0.5 seconds) transmit a signal (e.g., the signal 405) representative of a parameter of the electrode material 165 to the control device 155 after measuring the parameter via the sensor 150. The control device 155 can promptly (e.g., within less than 0.5 seconds) transmit a signal (e.g., the signal 410) to the vacuum device 120 to prompt an operation of the vacuum device 120 upon receiving the signal 405 from the sensor device 145. The vacuum device 120 can apply the vacuum pressure at the coating opening 190 via the vacuum chamber 125 by opening the valve 135 promptly (e.g., within less than 0.5 seconds) upon receiving the signal 410 from the control device 155.

The system 100 can include the vacuum device 120 to apply the vacuum pressure based on a comparison of a signal with a threshold value. For example, the vacuum device 120 can apply the vacuum pressure at the coating opening 190 based on the signal representative of a parameter of the electrode material 165 provided by the sensor device 145 to the control device 155. The vacuum device 120 can apply the vacuum pressure if the signal representative of the parameter of the electrode material 165 indicates that the parameter of the electrode material 165 is higher, lower, or otherwise different than a threshold value. For example, the signal can be a signal representative of a thickness 305 or density of the electrode material 165 applied to the current collector material 160. The vacuum device 120 can apply the vacuum pressure at the coating opening 190 to control the electrode material 165 (e.g., to reduce a thickness 305 or density of the electrode material 165) if the signal representative of the thickness 305 or density of the electrode material 165 exceeds a threshold value, is lower than a threshold value, or bears some other relationship with respect to the threshold value. The threshold value can be a desired thickness or density, an upper bound of a thickness or density tolerance range, or some other value.

The threshold value can be set by a user (e.g., operator of the system 100). The threshold value can be determined via machine learning algorithm, mathematical function, or based on some other parameter of the electrode material 165, current collector material 160, or slot die coating system 105 operating parameter (e.g., coating velocity). For example, the threshold value can be determined based on a viscosity of the electrode material 165 within the cavity 205 of the slot die coating system 105. The threshold value can be determined based on a material composition of the current collector material 160 (e.g., copper-based material, aluminum-based material, or other material). The threshold value can be determined based on a material composition of the electrode material 165, for example.

The system 100 can include the control device 155 to compare the signal representative of the electrode material 165 with the threshold value. For example, the system 100 can include the control device 155 to receive the signal 405 representative of a parameter of the electrode material 165 or a portion 170 of the electrode material 165. The control device 155 can store (e.g., via a local memory device) the threshold value or can obtain the threshold value via communication with the computing system 185. For example, the control device 155 can receive, via wireless communication with the computing system 185, the threshold value. The control device 155 can compare the threshold value with the signal 405 to determine whether the parameter of the electrode material 165 represented by the signal 405 is greater than, less than, or equal to the threshold value. For example, the control device 155 can compare the threshold value with the signal 405 to determine that a thickness 305 of a portion 170 of the electrode material 165 is greater than the threshold value. The control device 155 can transmit the signal 410 to the valve 135 of the vacuum device 120 to cause the actuating member of the valve 135 to move from a closed position to an open position based on the determination that the thickness 305 of a portion 170 of the electrode material 165 is greater than the threshold value. The control device 155 can compare the threshold value with the signal 405 to determine a degree to which a thickness 305 of a portion 170 of the electrode material 165 is greater than the threshold value. The control device 155 can provide the signal 410 to the valve 135 or the pump 140, where the signal 410 can include a command to apply a particular vacuum pressure (e.g., 760 mTorr pressure, a 250 mTorr pressure, a 1 mTorr pressure) based on the determined degree to which the thickness 305 of the portion 170 of the electrode material 165 exceeds the threshold value.

The system 100 can include the vacuum device 120 to provide a signal to the control device 155. For example, the pump 140, the valve 135, the vacuum chamber 125, or some other component of the vacuum device 120 can be communicably coupled with the control device 155 (e.g., via a wireless communication protocol such as or via a wired communication protocol) and can be configured to transmit data, information, or signals to the control device 155. The pump 140, for example, can provide a signal to the control device 155 representative of a current vacuum pressure created by the pump 140. The valve 135 can provide a signal to the control device 155 of a current state of the valve 135 (e.g., whether the valve 135 is in the open position or in the closed position). The vacuum chamber 125 can include a pressure sensor or other measurement device configured to determine a pressure within the vacuum chamber 125. The vacuum chamber 125 or the vacuum device 120 can provide a signal representative of a pressure within the vacuum chamber 125 to the control device 155. Each of the components of the vacuum device 120 can be communicably coupled with the other components of the vacuum device 120. For example, the pump 140 can be communicably coupled with the vacuum chamber 125 and can receive from the vacuum chamber 125 a signal representative of a pressure within the vacuum chamber 125. The pump 140 can vary a displacement to correspondingly vary the pressure in the vacuum chamber 125 based on the signal representative of the pressure in the vacuum chamber 125.

The system 100 can include the vacuum device 120 to apply a particular vacuum pressure based on at least one parameter associated with the electrode material 165, the current collector material 160, or the slot die coating system 105. The parameter associated with the electrode material 165 can be a parameter measured by the sensor device 145, a known parameter associated with the electrode material 165 (e.g., a material viscosity), or some other parameter associated with the electrode material 165 that is measured (e.g., by a user, during another manufacturing process, or otherwise) and provided to the control device 155. The parameter associated with the current collector material 160 can be a chemical or material composition of the current collector material 160, a thickness of the current collector material 160, a temperature of the current collector material 160, or some other parameter. The parameter associated with the slot die coating system 105 can be the coating gap distance 300, a volumetric flow rate of the electrode material 165 via the coating opening 190, or some other parameter.

The system 100 can apply the particular vacuum pressure via the vacuum device 120 to control the electrode material 165 based on the parameter using a mathematical formula. For example, the system 100 can apply a minimum vacuum pressure to the electrode material 165 to control a thickness 305 of the electrode material 165. The control device 155 can determine an appropriate vacuum pressure for the vacuum device 120 to apply in order to control the thickness 305 of the electrode material 165 in a particular manner. The control device 155 can estimate the vacuum pressure that can be applied by the vacuum device 120 to ensure coating uniformity. The vacuum required is proportional to viscosity at slot, volumetric flow rate, or shim thickness (e.g., gap of slot down lip and upper lip). The vacuum required for a stable coating is inversely proportional to gap between the slot die and substrate and coating thickness. The control device 155 can apply a formula that considers, among other possible variables, a viscosity of the electrode material 165 at the coating opening 190, a volumetric flow rate of the electrode material 165 from the slot die coating system 105, a measured difference between a threshold thickness value and the measured thickness 305 of the electrode material 165 downstream from the coating opening 190, the coating gap distance 300, and a thickness 305 of the electrode material 165 downstream of the coating opening 190, whether measured by the sensor device 145 or a user-input threshold thickness value. These variables, among others, can be used to calculate a vacuum pressure that can be applied by the vacuum device 120 at the coating opening 190 via the vacuum chamber 125. The vacuum pressure can be calculated using the above-listed variables, among others, to determine an appropriate vacuum pressure at which the thickness 305 of the electrode material 165 that has been applied to the current collector material 160 can be controlled (e.g., modulated, modified, steadied, maintained, or otherwise influenced). Other variables can also be used to calculate a vacuum pressure. The variables can be measured variables or user-provided variables (e.g., threshold values, known material properties, input variables on the slot die coating system, or otherwise).

The control device 155 can determine the vacuum pressure value based on the above formula or some other formula and can provide a signal to the vacuum device 120 to create a vacuum pressure according to the determined vacuum pressure value. For example, the control device 155 can provide a command signal to the vacuum device 120, which can cause the pump 140 of the vacuum device 120 to create the vacuum pressure and can cause at least one valve 135 to automatically open to fluidly couple the vacuum chamber 125 with the pump 140. The pump 140 can apply the vacuum pressure within the vacuum chamber 125, and the vacuum chamber 125 can apply the vacuum pressure at the coating opening 190. The control device 155 can provide a signal to the vacuum device 120, whereupon the vacuum device 120 can cause the pump 140 to create the vacuum pressure or cause the valve 135 to move from the closed position to the open position, or the control device 155 can provide a signal directly to the pump 140 causing the pump 140 to create the vacuum pressure or provide a signal direction to the valve 135 to cause the valve to move from the closed position to the open position.

The control device 155 can determine multiple vacuum pressure values. For example, the control device 155 can determine a vacuum pressure value associated with each portion 170 of the electrode material 165 based on multiple signals provided to the control device 155 via the sensor device 145, where each of the multiple signals are associated with a measurement from a sensor 150 associated with a portion 170 of the electrode material 165. The control device 155 can determine a minimum vacuum pressure for each portion 170 of the electrode material 165 based on a measured thickness 305 of the electrode material 165 applied to the current collector material 160. Because the thickness 305 of the electrode material 165 can vary from portion 170 to portion 170 (e.g., as a result of undesirable material variation), the vacuum pressure value associated with one portion 170 can differ from a vacuum pressure value associated with another portion 170. The system 100 can apply different vacuum pressures at the coating opening 190 to control different portions 170 of the electrode material 165 to varying degrees. For example, the system 100 can apply different vacuum pressures to different portions 170 of the electrode material to reduce or otherwise control a thickness 305 of the electrode material 165 in order to achieve a consistent (e.g., uniform, regular) thickness 305 value from portion 170 to portion 170. The electrode material 165 applied to the current collector material 160 can include a uniform, consistent, or regular material thickness 305 from across the entire width 167 of the electrode material 165. For example, the electrode material 165 can have a thickness 305 variance of ±less than 1%, ±1%, ±1-3%, or ±5% from portion 170 to portion 170 or across the width 167.

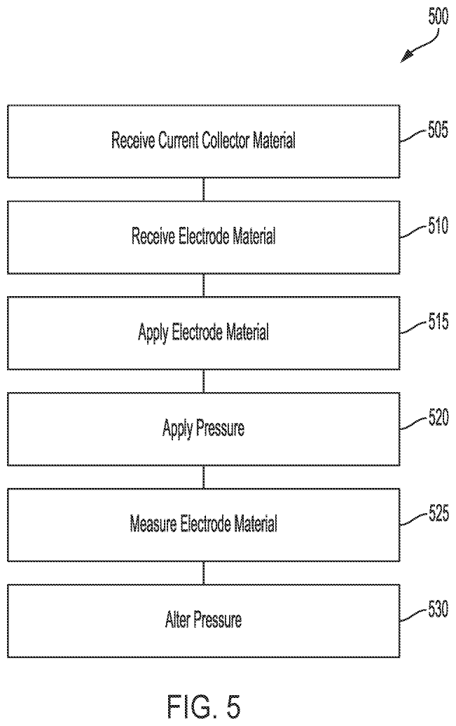

FIG. 5, among others, depicts an example method 500 of operating a system for manufacturing a battery electrode. For example, the method 500 can be a method of operating the system 100, the system 100 including the slot die coating system 105, the vacuum device 120, the sensor device 145, and the control device 155 as herein described. The method 500 can include one or more of ACTS 505-530. The method 500 can be performed by the system 100 or by one or more components of the system 100, such as the slot die coating system 105, the vacuum device 120, the sensor device 145, or the control device 155.

The method 500 can include receiving a current collector material at ACT 505. For example, the method 500 can include receiving the current collector material 160 proximate to (e.g., close to, near to, adjacent to, within a predetermined distance of) the coating opening 190 of the slot die coating system 105. The current collector material 160 can be provided between the roller 200 and the coating opening 190 of the slot die coating system 105. The current collector material 160 can be can be provided between a conveyor mechanism (e.g., a conveyor substrate, a conveyor belt, a conveyor mechanism including at least one roller, or some other mechanism) and the coating opening 190 of the slot die coating system 105. The current collector material 160 can be provided proximate to the slot die coating system 105 such that the slot die coating system 105 can apply the electrode material 165 to the current collector material 160. For example, the coating opening 190 of the slot die coating system 105 can be spaced apart from the coating opening 190 such that the coating gap distance 300 exists between the first surface 210 and the slot die coating system 105. The current collector material 160 can move in a first direction 175 or can rotate around an arcuate portion of an outer surface of the roller 200 as the roller rotates in the roller direction 220. For example, the current collector material 160 can move in the first direction 175, where the first direction 175 can be similar to or different than the roller direction 220. The first direction 175 can be a direction that is tangent to a point on the surface of the roller near the coating opening 190 or some other direction.

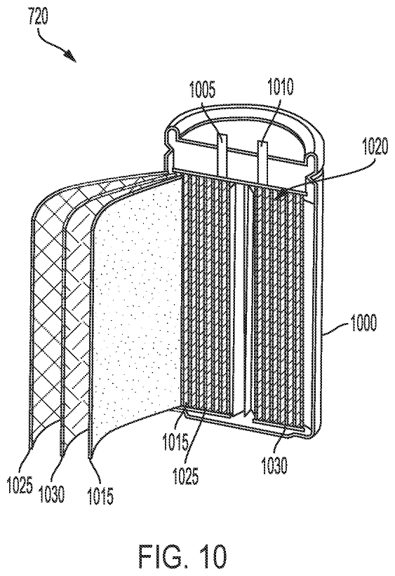

The method 500 can include receiving electrode material at ACT 510. For example, the method 500 can include receiving the electrode material 165 in the cavity 205 of the slot die coating system 105 at ACT 510. The electrode material 165 can be a viscous material (e.g., a slurry). The electrode material 165 can be a cathodic material or an anodic material such as those described above with reference to FIGS. 10-12. The electrode material 165 can be a material that, after a certain amount of time or after exposed to a certain degree of heat for a certain amount of time, can become dried, solidified, hardened, or otherwise cured. The electrode material 165 can remain in a viscous form while within the cavity 205 of the slot die coating system 105.

The method 500 can include applying electrode material at ACT 515. For example, the method 500 can include applying the electrode material received at ACT 510 to the current collector material 160 received at ACT 505. The slot die coating system 105 can apply the electrode material 165 to the current collector 160 with the current collector material 160 spaced apart from the coating opening 190 by the coating gap distance 300. The slot die coating system 105 can apply the electrode material 165 between the first die 110 and the second die 115. The slot die coating system 105 can apply the electrode material 165 to the current collector material 160 via the coating opening 190. For example, the slot die coating system 105 can include a pump, where the pump can push (e.g., force, dispense) the electrode material 165 out of the cavity 205 via the coating opening 190 and onto the first surface 210 of the current collector material 160 at a volumetric flow rate.

The method 500 can include applying a pressure at ACT 520. For example, the method 500 can include applying a vacuum pressure via the vacuum device 120 at ACT 520. The method 500 can include applying the vacuum pressure at (e.g., proximate to, near to, close to, within a predetermined distance of, adjacent to) the coating opening 190. The vacuum device 120 can apply the vacuum pressure to control the electrode material 165 that is applied to the current collector material 160 at ACT 520. The vacuum device 120 can apply the vacuum pressure to reduce a thickness 305 of the electrode material 165. The vacuum device 120 can include the vacuum chamber 125, the valve 135, and the pump 140. The vacuum device 120 can apply the vacuum pressure with the pump 140 fluidly coupled with the vacuum chamber 125. For example, the vacuum device 120 can apply the vacuum pressure to the vacuum chamber 125 with the valve 135 in an open position. The vacuum chamber 125 can include an opening 230. The opening 230 can be positioned at e.g., proximate to, near to, close to, adjacent to, within 1-50 mm of, or directly contacting) the coating opening 190 and configured to pull or draw the electrode material 165 towards the vacuum chamber. For example, the vacuum device 120 can apply the vacuum pressure to pull or draw the electrode material 165 in the vacuum direction 225. The vacuum direction 225 (e.g., an upstream direction) can be opposite the first direction 175 in which the current collector material 160 advances (e.g., a downstream direction). As shown in FIGS. 1, 3A, and 3B, among others, the current collector can move in the first direction 175 where the first direction is a substantially linear direction. As depicted in FIG. 2, among others, the current collector material 160 can travel in the first direction 175 relative to slot die coating system 105 where the first direction 175 can be arcuate, curved, or nonlinear, for example. The vacuum direction 225 can be at least partially opposed to the first direction 175 whether the first direction 175 is linear, non-linear, or takes some other form. The method 500 can include applying the vacuum pressure to various portions of the coating opening 190 via multiple vacuum chambers 125, each vacuum chamber 125 associated with a portion 170 of the electrode material 165. For example, the vacuum device 120 can include multiple vacuum chambers that include an opening 230 at (e.g., proximate to, close to, near to, adjacent to, within a predetermined distance of) a portion of the coating opening 190 that is associated with a portion 170 of the electrode material 165. Each portion 170 of the electrode material 165 can be independently controlled via a vacuum chamber 125, for example.

The method 500 can include measuring the electrode material. For example, the method 500 can include measuring a parameter of the electrode material 165 that has been applied to the current collector material 160 via the sensor device 145. The sensor device 145 can include at least one sensor 150. For example, the sensor device 145 can include one sensor associated with each portion 170 of the electrode material 165. The sensor 150 can measure a parameter of the portion 170 of the electrode material 165. For example, the sensor 150 can measure a thickness 305 of the electrode material 165, a density of the electrode material 165, or some other parameter associated with the electrode material 165. The sensor device 145 can provide a signal to the vacuum device 120 where the signal can be representative of the measured parameter or measured parameters of the electrode material 165. For example, the sensor device 145 can provide the signal to the control device 155 of the system 100. The sensor device 145 can be positioned near to the slot die coating system 105. For example, the sensor device 145 can be adjacent the first die 110 of the slot die coating system 105 such that the sensor 150 of the sensor device 145 obtains a measurement of the electrode material 165 shortly after (e.g., immediately after, within one second, within five seconds) of the measured electrode material 165 being applied to the current collector material 160 at ACT 515.

The method 500 can include altering a pressure at ACT 530. For example, the method 500 can include altering a vacuum pressure applied by the vacuum device 120 at (e.g., proximate to, near to, close to, adjacent to, within a predetermined distance of) the coating opening 190 of the slot die coating system 105. The method 500 can include altering the vacuum pressure based on a measured parameter of the electrode material 165, such as the parameter measured at ACT 525. For example, the vacuum pressure can be strengthened (e.g., the pressure decreased) or weakened (e.g., the pressure increased) based on the measured thickness 305 of the electrode material 165 as measured at ACT 525. For example, the control device 155 can receive the signal representative of a measured parameter of the electrode material 165 at ACT 525. The control device 155 can determine, based on the received signal, whether or not the vacuum pressure needs to be adjusted or altered to achieve a desired result. The control device 155 can, for example, compare the measured parameter with a threshold value to determine if the vacuum pressure should be altered. The vacuum pressure can be strengthened to further reduce the thickness 305 of the electrode material 165, or the vacuum pressure can be weakened to increase the thickness 305 of the electrode material 165. The vacuum pressure can be eliminated entirely such that the slot die coating system 105 applies the electrode material 165 at an ambient pressure, which can increase a thickness 305 of the electrode material 165 relative to the thickness resulting from an application of vacuum pressure. The vacuum pressure can be adjusted by changing a displacement of the pump 140 or by changing a position of an actuating member of the valve 135 to a position that is closer to a fully open position or closer to a fully closed position. The adjustment of the position of the actuating member can be automatic. The position of the actuating member can be adjusted in substantially real time (e.g., within 0.1 seconds, within one second, or within some other time interval) based on the measurement obtained at ACT 525. ACTS 525 and 530 can be iterative such that the method 500 continuously measures a parameter of the electrode material 165, which causes a continuous alteration or adjustment of the vacuum pressure.

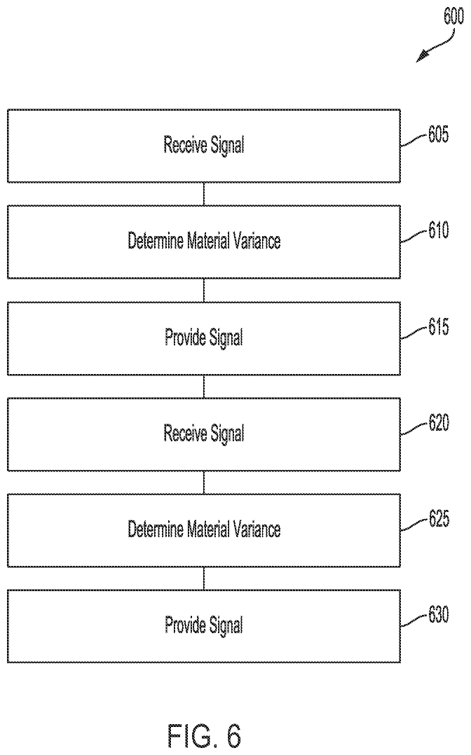

FIG. 6 among others, depicts an example method 600 of operating or controlling a system for manufacturing a battery electrode. For example, the method 600 can be a method of controlling the system 100 via the control device 155. The system 100 including the slot die coating system 105, the vacuum device 120, and the sensor device 145, and the control device 155 as herein described. The method 600 can include one or more of ACTS 605-630. The method 600 can be performed by the control device 155 or by one or more other components of the system 100, such as the slot die coating system 105, the vacuum device 120, or the sensor device 145.

The method 600 can include receiving a signal at ACT 605. For example, the method 600 can include the control device 155 receiving a signal (e.g., the signal 405) from the sensor device 145 at ACT 605. The signal 405 can be a signal representative of a measured parameter of the electrode material 165. The signal 405 can be a signal representative of a thickness 305 of the electrode material 165. The signal 405 can include a signal that is representative of multiple measurements of the thickness 305 of multiple portions 170 of the electrode material 165. The measured parameter can be a density of the electrode material 165 or some other parameter of the electrode material 165.

The method 600 can include determining a material variance at ACT 610. For example, the method 600 can include determining a difference between the measured parameter of the electrode material 165 as represented by the signal 405 and a threshold value. The control device 155 can compare the measured parameter of the electrode material 165 with the threshold value to determine the extent to which and a direction in which the actual measured electrode material 165 varies from a desired electrode material 165 (e.g., an electrode material represented by the threshold value). For example, the control device 155 can determine that the measured thickness 305 of the electrode material 165 is greater than a threshold thickness value. If the signal 405 received at ACT 605 includes information related to multiple portions 170 of the electrode material 165, the control device 155 can determine a material variance for each of the portions 170 of the electrode material 165 represented by the signal 405.

The method 600 can include providing a signal at ACT 615. For example, the method 600 can include the control device 155 providing a signal 410 (e.g., a command) to the vacuum device 120 at ACT 615. The control device 155 can determine, based on the material variance determined at ACT 610, to operate the vacuum device 120 in order to control or influence the electrode material 165. For example, the material variance determined at ACT 610 can indicate that a thickness 305 of the electrode material 165 exceeds a desired bound. The control device 155 can provide a command to the vacuum device 120 to cause the vacuum device 120 to apply a vacuum pressure at the coating opening 190 to control (e.g., modify, modulate, affect, manipulate, alter) the electrode material 165 applied to the current collector material 160. The signal 410 can include an instruction for the valve 135 to move from a closed position to an open position or from an open position to a closed position. The signal 410 can include a command for the pump 140 to create a particular vacuum pressure or to change a vacuum pressure (e.g., change a displacement of the pump 140). The signal 410 can include an instruction to the valve 135 to automatically adjust a position of an actuating member of the valve 135 to maintain a desired vacuum pressure at the coating opening 190. For example, the valve 135 can automatically adjust a position of the actuating member based on a pressure measurement indicative of a pressure within the vacuum chamber 125. The signal 410 can include a command for the vacuum device 120 to apply the vacuum pressure at multiple portions of the coating opening 190 via multiple vacuum chambers 125. The control device 155 can provide multiple signals 410 to the vacuum device 120. For example, the control device 155 can transmit a signal 410 to each of multiple valves 135 to cause each valve 135 to operate (e.g., move from a closed position to an open position) to apply the vacuum pressure at a portion of the coating opening 190 associated with a portion 170 of the electrode material 165.

The method 600 can include receiving a signal at ACT 620. For example, the method 600 can include the control device 155 receiving a second signal 405 from the sensor device 145. The second signal 405 can be a signal representative of a parameter of the electrode material 165 at a second time (e.g., a time subsequent to a time associated with the signal 405 received at ACT 605). The second signal 405 can be a signal representative of a thickness 305 of the electrode material 165. The second signal 405 can include a signal that is representative of multiple measurements of the thickness 305 of multiple portions 170 of the electrode material 165. The measured parameter can be a density of the electrode material 165 or some other parameter of the electrode material 165. For example, the second signal 405 can be a density, thickness 305, or other parameter of the electrode material 165 after application of the vacuum pressure at the coating opening 190 (or at multiple portions of the coating opening 190) via the vacuum device 120 in response to the signal provided at ACT 615. The second signal 405 can reflect any changes to the electrode material 165 resulting from the application of the vacuum pressure.

The method 600 can include determining a material variance at ACT 625. For example, the method 600 can include determining a difference between the measured parameter of the electrode material 165 as represented by the second signal 405 and a threshold value. The control device 155 can compare the measured parameter of the electrode material 165 with the threshold value to determine the extent to which and a direction in which the actual measured electrode material 165 varies from a desired electrode material 165 (e.g., an electrode material represented by the threshold value). For example, the control device 155 can determine that the measured thickness 305 of the electrode material 165 is greater than or less than a threshold thickness value. If the second signal 405 received at ACT 620 includes information related to multiple portions 170 of the electrode material 165, the control device 155 can determine a material variance for each of the portions 170 of the electrode material 165 represented by the second signal 405.

The method 600 can include providing a signal at ACT 630. For example, the method 600 can include the control device 155 providing a second signal 410 (e.g., a command) to the vacuum device 120 at ACT 630. The control device 155 can determine, based on the material variance determined at ACT 625, to operate the vacuum device 120 in order to control or influence the electrode material 165 or to alter an operation of the vacuum device 120 in order to control or influence the electrode material 165. For example, the material variance determined at ACT 625 can indicate that a thickness 305 of the electrode material 165 is at or near to a desired bound. The control device 155 can provide a command to the vacuum device 120 to cause the vacuum device 120 to weaken an a vacuum pressure at the coating opening 190 relative to the vacuum pressure prescribed by the signal 410 at ACT 615. For example, the weaker vacuum pressure can prevent further reduction in a thickness 305 of the electrode material 165 and instead maintain a desired thickness. In other examples, the second signal 410 can be a signal to strengthen a vacuum pressure at the coating opening 190 relative to the vacuum pressure prescribed by the signal 410 at ACT 615 to further control (e.g., modify, modulate, affect, manipulate, alter) the electrode material 165 applied to the current collector material 160. The second signal 410 can include an instruction for the valve 135 to move from a closed position to an open position or from an open position to a closed position. The second signal 410 can include a command for the pump 140 to create a particular vacuum pressure or to change a vacuum pressure (e.g., change a displacement of the pump 140). The second signal 410 can include an instruction to the valve 135 to automatically adjust a position of an actuating member of the valve 135 to maintain a desired vacuum pressure at the coating opening 190. For example, the valve 135 can automatically adjust a position of the actuating member based on a pressure measurement indicative of a pressure within the vacuum chamber 125. The second signal 410 can include a command for the vacuum device 120 to apply the vacuum pressure at multiple portions of the coating opening 190 via multiple vacuum devices 125. The control device 155 can provide multiple second signals 410 to the vacuum device 120. For example, the control device 155 can transmit a signal 410 to each of multiple valves 135 to cause each valve 135 to operate (e.g., move from a closed position to an open position) to apply the vacuum pressure at a portion of the coating opening 190 associated with a portion 170 of the electrode material 165.

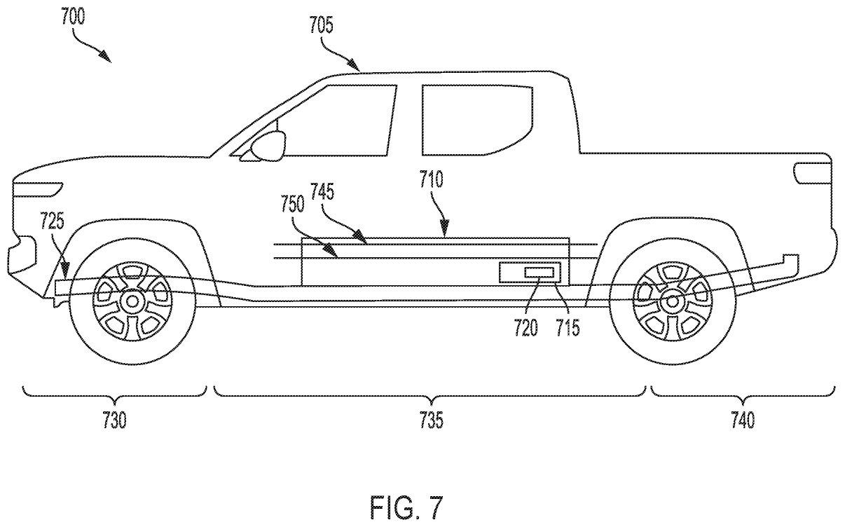

FIG. 7 depicts an example cross-sectional view 700 of an electric vehicle 705 installed with at least one battery pack 710. Electric vehicles 705 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 710 can also be used as an energy storage system to power a building, such as a residential home or commercial building. Electric vehicles 705 can be fully electric or partially electric (e.g., plug-in hybrid) and further, electric vehicles 705 can be fully autonomous, partially autonomous, or unmanned. Electric vehicles 705 can also be human operated or non-autonomous. Electric vehicles 705 such as electric trucks or automobiles can include on-board battery packs 710, battery modules 715, or battery cells 720 to power the electric vehicles. The electric vehicle 705 can include a chassis 725 (e.g., a frame, internal frame, or support structure). The chassis 725 can support various components of the electric vehicle 705. The chassis 725 can span a front portion 730 (e.g., a hood or bonnet portion), a body portion 735, and a rear portion 740 (e.g., a trunk, payload, or boot portion) of the electric vehicle 705. The battery pack 710 can be installed or placed within the electric vehicle 705. For example, the battery pack 710 can be installed on the chassis 725 of the electric vehicle 705 within one or more of the front portion 730, the body portion 735, or the rear portion 740. The battery pack 710 can include or connect with at least one busbar, e.g., a current collector element. For example, the first busbar 745 and the second busbar 750 can include electrically conductive material to connect or otherwise electrically couple the battery modules 715 or the battery cells 720 with other electrical components of the electric vehicle 705 to provide electrical power to various systems or components of the electric vehicle 705.

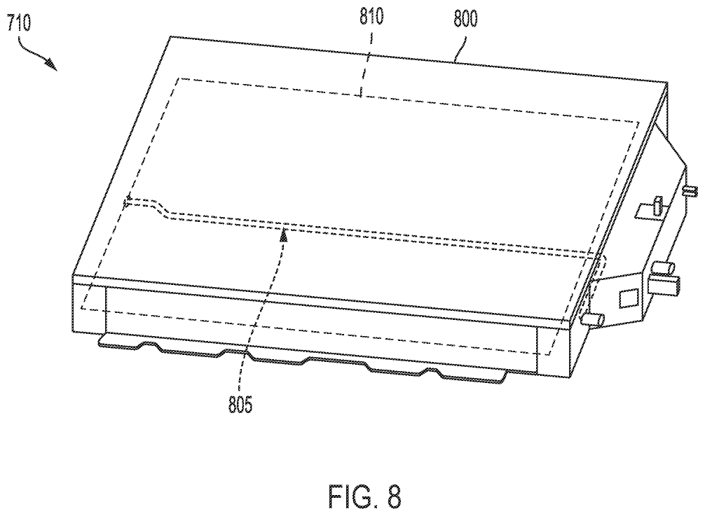

FIG. 8 depicts an example battery pack 710. Referring to FIG. 8, among others, the battery pack 710 can provide power to electric vehicle 705. Battery packs 710 can include any arrangement or network of electrical, electronic, mechanical or electromechanical devices to power a vehicle of any type, such as the electric vehicle 705. The battery pack 710 can include at least one housing 800. The housing 800 can include at least one battery module 715 or at least one battery cell 720, as well as other battery pack components. The housing 800 can include a shield on the bottom or underneath the battery module 715 to protect the battery module 715 from external conditions, for example if the electric vehicle 705 is driven over rough terrains (e.g., off-road, trenches, rocks, etc.) The battery pack 710 can include at least one cooling line 805 that can distribute fluid through the battery pack 710 as part of a thermal/temperature control or heat exchange system that can also include at least one thermal component (e.g., cold plate) 810. The thermal component 810 can be positioned in relation to a top submodule and a bottom submodule, such as in between the top and bottom submodules, among other possibilities. The battery pack 710 can include any number of thermal components 810. For example, there can be one or more thermal components 810 per battery pack 710, or per battery module 715. At least one cooling line 805 can be coupled with, part of, or independent from the thermal component 810.

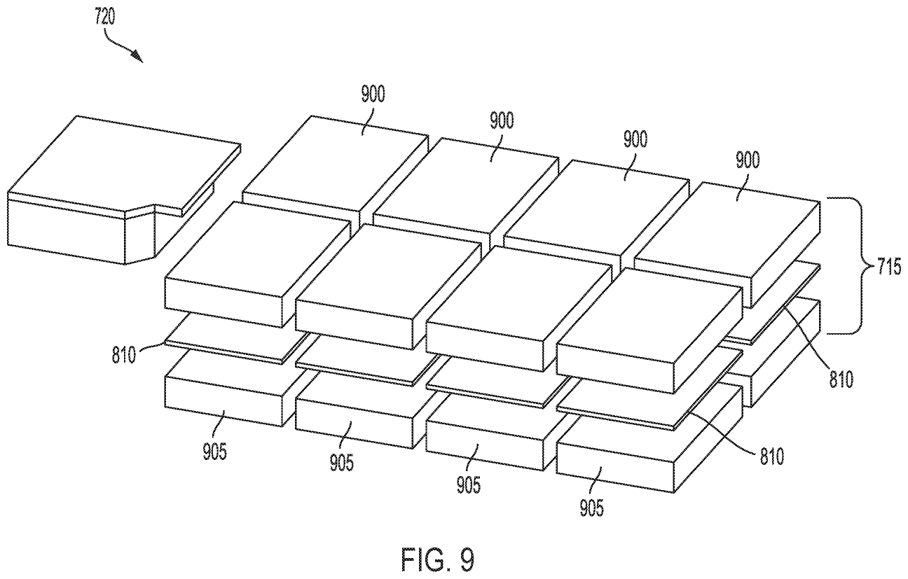

FIG. 9 depicts example battery modules 715, and FIGS. 10-12 depict an example cross sectional view of a battery cell 720. The battery modules 715 can include at least one submodule. For example, the battery modules 715 can include at least one first (e.g., top) submodule 900 or at least one second (e.g., bottom) submodule 905. At least one thermal component 810 can be disposed between the top submodule 900 and the bottom submodule 905. For example, one thermal component 810 can be configured for heat exchange with one battery module 715. The thermal component 810 can be disposed or thermally coupled between the top submodule 900 and the bottom submodule 905. One thermal component 810 can also be thermally coupled with more than one battery module 715 (or more than two submodules 900, 905). The battery submodules 900, 905 can collectively form one battery module 715. In some examples each submodule 900, 905 can be considered as a complete battery module 715, rather than a submodule.

The battery modules 715 can each include a plurality of battery cells 720. The battery modules 715 can be disposed within the housing 800 of the battery pack 710. The battery modules 715 can include battery cells 720 that are cylindrical cells or prismatic cells, for example. The battery module 715 can operate as a modular unit of battery cells 720. For example, a battery module 715 can collect current or electrical power from the battery cells 720 that are included in the battery module 715 and can provide the current or electrical power as output from the battery pack 710. The battery pack 710 can include any number of battery modules 715. For example, the battery pack can have one, two, three, four, five, six, seven, eight, nine, ten, eleven, twelve or other number of battery modules 715 disposed in the housing 800. It should also be noted that each battery module 715 may include a top submodule 900 and a bottom submodule 905, possibly with a thermal component 810 in between the top submodule 900 and the bottom submodule 905. The battery pack 710 can include or define a plurality of areas for positioning of the battery module 715. The battery modules 715 can be square, rectangular, circular, triangular, symmetrical, or asymmetrical. In some examples, battery modules 715 may be different shapes, such that some battery modules 715 are rectangular but other battery modules 715 are square shaped, among other possibilities. The battery module 715 can include or define a plurality of slots, holders, or containers for a plurality of battery cells 720.

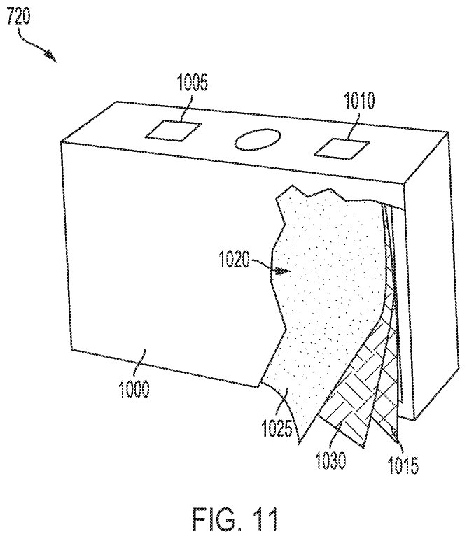

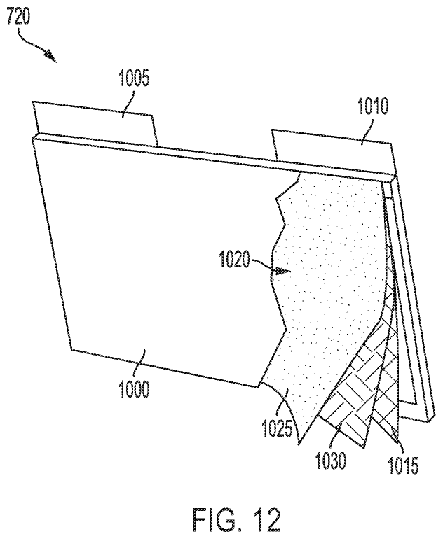

Battery cells 720 have a variety of form factors, shapes, or sizes. For example, battery cells 720 can have a cylindrical, rectangular, square, cubic, flat, pouch, elongated or prismatic form factor. As depicted in FIG. 10, for example, the battery cell 720 can be cylindrical. As depicted in FIG. 11, for example, the battery cell 720 can be prismatic. As depicted in FIG. 12, for example, the battery cell 720 can include a pouch form factor. Battery cells 720 can be assembled, for example, by inserting a winded or stacked electrode roll (e.g., a jelly roll) including electrolyte material into at least one battery cell housing 1000. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 720 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 720. The housing 1000 can be of various shapes, including cylindrical or rectangular, for example. Electrical connections can be made between the electrolyte material and components of the battery cell 720. For example, electrical connections to the electrodes with at least some of the electrolyte material can be formed at two points or areas of the battery cell 720, for example to form a first polarity terminal 1005 (e.g., a positive or anode terminal) and a second polarity terminal 1010 (e.g., a negative or cathode terminal). The polarity terminals can be made from electrically conductive materials to carry electrical current from the battery cell 720 to an electrical load, such as a component or system of the electric vehicle 705.

For example, the battery cell 720 can include a lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 720 to separate the anode and cathode from each other and to facilitate transfer of lithium ions between the anode and cathode. It should be noted that battery cell 720 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂ (XO₄)₃ (A=Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 720 can be included in battery modules 715 or battery packs 710 to power components of the electric vehicle 705. The battery cell housing 1000 can be disposed in the battery module 715, the battery pack 710, or a battery array installed in the electric vehicle 705. The housing 1000 can be of any shape, such as cylindrical with a circular (e.g., as depicted in FIG. 10, among others), elliptical, or ovular base, among others. The shape of the housing 1000 can also be prismatic with a polygonal base, as shown in FIG. 11, among others. As shown in FIG. 12, among others, the housing 1000 can include a pouch form factor. The housing 1000 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 1000 of the battery cell 720 can include one or more materials with various electrical conductivity or thermal conductivity, or a combination thereof. The electrically conductive and thermally conductive material for the housing 1000 of the battery cell 720 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1000 of the battery cell 720 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1000 of the battery cell 720 is prismatic (e.g., as depicted in FIG. 11, among others) or cylindrical (e.g., as depicted in FIG. 10, among others), the housing 1000 can include a rigid or semi-rigid material such that the housing 1000 is rigid or semi-rigid (e.g., not easily deformed or manipulated into another shape or form factor). In examples where the housing 1000 includes a pouch form factor (e.g., as depicted in FIG. 12, among others), the housing 1000 can include a flexible, malleable, or non-rigid material such that the housing 1000 can be bent, deformed, manipulated into another form factor or shape.

The battery cell 720 can include at least one anode layer 1015, which can be disposed within the cavity 1020 defined by the housing 1000. The anode layer 1015 can be manufactured by the system 100. For example, the anode layer 1015 can be or include the battery electrode 195 and can include the electrode material 165 applied to the current collector material 160. The anode layer 1015 can include a first redox potential. The anode layer 1015 can receive electrical current into the battery cell 720 and output electrons during the operation of the battery cell 720 (e.g., charging or discharging of the battery cell 720). The anode layer 1015 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 720 can include at least one cathode layer 1025 (e.g., a composite cathode layer compound cathode layer, a compound cathode, a composite cathode, or a cathode). The cathode layer 1025 can be manufactured by the system 100. For example, the cathode layer 1025 can be or include the battery electrode 195 and can include the electrode material 165 applied to the current collector material 160. The cathode layer 1025 can include a second redox potential that can be different than the first redox potential of the anode layer 1015. The cathode layer 1025 can be disposed within the cavity 1020. The cathode layer 1025 can output electrical current out from the battery cell 720 and can receive electrons during the discharging of the battery cell 720. The cathode layer 1025 can also release lithium ions during the discharging of the battery cell 720. Conversely, the cathode layer 1025 can receive electrical current into the battery cell 720 and can output electrons during the charging of the battery cell 720. The cathode layer 1025 can receive lithium ions during the charging of the battery cell 720.

The battery cell 720 can include an electrolyte layer 1030 disposed within the cavity 1020. The electrolyte layer 1030 can be arranged between the anode layer 1015 and the cathode layer 1025 to separate the anode layer 1015 and the cathode layer 1025. The electrolyte layer 1030 can help transfer ions between the anode layer 1015 and the cathode layer 1025. The electrolyte layer 1030 can transfer Li⁺ cations from the anode layer 1015 to the cathode layer 1025 during the discharge operation of the battery cell 720. The electrolyte layer 1030 can transfer lithium ions from the cathode layer 1025 to the anode layer 1015 during the charge operation of the battery cell 720.

The redox potential of layers (e.g., the first redox potential of the anode layer 1015 or the second redox potential of the cathode layer 1025) can vary based on a chemistry of the respective layer or a chemistry of the battery cell 720. For example, lithium-ion batteries can include an LFP (lithium iron phosphate) chemistry, LMFP (lithium manganese, iron phosphate) chemistry, an NMC (Nickel Manganese Cobalt) chemistry, an NCA (Nickel Cobalt Aluminum) chemistry, an OLO (overlithiated oxide) chemistry, or an LCO (lithium cobalt oxide) chemistry for a cathode layer (e.g., the cathode layer 1025). Lithium-ion batteries can include a graphite chemistry, a silicon-graphite chemistry, or a lithium metal chemistry for the anode layer (e.g., the anode layer 1015).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), a layered oxides (LiMO₂, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers such as the electrode material 165 can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 1025) medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 1015) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers such as the electrode material 165 can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials such as the current collector material 160 (e.g., a current collector foil to which an electrode active material such as the electrode material 165 is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 1030 can include or be made of a liquid electrolyte material. For example, the electrolyte layer 1030 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 1030 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 1030 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂ (XO₄)₃ (A=Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 1030 includes a liquid electrolyte material, the electrolyte layer 1030 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 1030 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 1030 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 1030 from greater than 0 M to about 1.5 M.

FIG. 13 depicts an example block diagram of an example computer system 185. The computer system or computing device 185 can include or be used to implement a data processing system or its components. The computing system 185 includes at least one bus 1300 or other communication component for communicating information and at least one processor 1305 or processing circuit coupled to the bus 1300 for processing information. The computing system 185 can also include one or more processors 1305 or processing circuits coupled to the bus for processing information. The computing system 185 also includes at least one main memory 1310, such as a random access memory (RAM) or other dynamic storage device, coupled to the bus 1300 for storing information, and instructions to be executed by the processor 1305. The main memory 1310 can be used for storing information during execution of instructions by the processor 1305. The computing system 185 may further include at least one read only memory (ROM) 1315 or other static storage device coupled to the bus 1300 for storing static information and instructions for the processor 1305. A storage device 1320, such as a solid state device, magnetic disk or optical disk, can be coupled to the bus 1300 to persistently store information and instructions.

The computing system 185 may be coupled via the bus 1300 to a display 1330, such as a liquid crystal display, or active matrix display, for displaying information to a user such as a driver of the electric vehicle 705 or other end user. An input device 1325, such as a keyboard or voice interface may be coupled to the bus 1300 for communicating information and commands to the processor 1305. The input device 1325 can include a touch screen display 1330. The input device 1325 can also include a cursor control, such as a mouse, a trackball, or cursor direction keys, for communicating direction information and command selections to the processor 1305 and for controlling cursor movement on the display 1330.

The processes, systems and methods described herein can be implemented by the computing system 185 in response to the processor 1305 executing an arrangement of instructions contained in main memory 1310. Such instructions can be read into main memory 1310 from another computer-readable medium, such as the storage device 1320. Execution of the arrangement of instructions contained in main memory 1310 causes the computing system 185 to perform the illustrative processes described herein. One or more processors in a multi-processing arrangement may also be employed to execute the instructions contained in main memory 1310. Hard-wired circuitry can be used in place of or in combination with software instructions together with the systems and methods described herein. Systems and methods described herein are not limited to any specific combination of hardware circuitry and software.

Although an example computing system has been described in FIG. 13, the subject matter including the operations described in this specification can be implemented in other types of digital electronic circuitry, or in computer software, firmware, or hardware, including the structures disclosed in this specification and their structural equivalents, or in combinations of one or more of them.

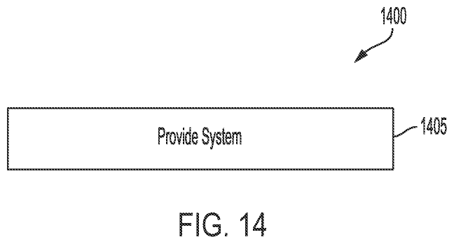

FIG. 14, among others, depicts an example method 1400 of providing a system. The method 1400 can include providing a system 100 for manufacturing an electrode at ACT 1405. For example, the method 1400 can include providing a system 100 for manufacturing a battery electrode 195. The battery electrode 195 can include a current collector material 160 coated with a battery electrode material 165. The system 100 can include a slot die coating system 105 and a vacuum device 120. The slot die coating system 105 can include a first die 110, a second die 115, and a coating opening 190. The slot die coating system 105 can receive the battery electrode material 165 in a cavity 205. The battery electrode material 165 can be a viscous material (e.g., a slurry, paste, or other substance). The slot die coating system 105 can apply the viscous battery electrode material 165 to a surface of the current collector material 160. The vacuum device 120 can include a vacuum chamber 125 in fluid communication with a pump 140 via a valve 135. The valve 135 can be in fluid communication with the pump 140 and can selectively allow the pump 140 to create a vacuum pressure within the vacuum chamber 125. The vacuum chamber 125 can be positioned at (e.g., proximate to, near to, close to, adjacent to, within 1-50 mm of, or directly contacting) the coating opening 190 of the slot die coating system 105. The vacuum device 120 can apply the vacuum pressure at the coating opening 190 to control (e.g., pull, bias, draw) the viscous electrode material 165. For example, the vacuum device 120 can apply the vacuum pressure at the coating opening 190 to control a thickness (e.g., thickness 305) of the electrode material 165 applied to the current collector material 160.

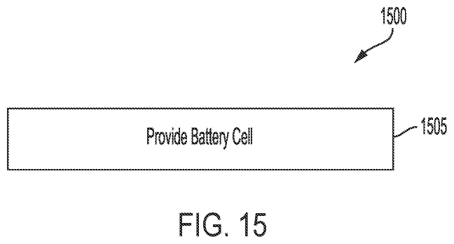

FIG. 15, among others, depicts an example method 1500 of providing a battery cell. The method 1500 can include providing a battery cell 720 at ACT 1505. The battery cell 720 can include an electrode manufactured by the system 100 or according to the method 500 or 600, among others. For example, the battery cell 720 can include a plurality of electrode layers, where at least one of the plurality of electrode layers can be the battery electrode 195. The battery electrode 195 can include the electrode material 165 applied to the current collector material 160 via the system 100. For example, the battery electrode 195 can be manufactured (e.g., produced) by applying, via the slot die coating system 105, the electrode material 165 to the current collector material. The battery electrode 195 can further be manufactured by applying, by the vacuum device 120, a vacuum pressure at the coating opening 190 of the slot die coating system 105 to control the electrode material 165. For example, the vacuum device 120 can apply, via the vacuum chamber 125, the vacuum pressure at (e.g., proximate to, near, close to) the coating opening 190 of the slot die coating system 105 to bias (e.g., pull, draw, suck) the electrode material 165 in a vacuum direction 225 to control a thickness 305 of the electrode material 165 applied to the current collector material 160.

Although discussed herein in the context of battery technology (e.g., the application of the electrode material 165 to the current collector material 160), it is understood that the system 100 can The system 100 can be configured to apply a different material (e.g., rubber, a polymeric material, a resin or epoxy, or other material) to various substrates (e.g., a metal substrate, a polymeric substrate, an organic substrate, or other material). For example, the system 100 can be used to apply an optical film to a transparent substrate. The system 100 can be used to apply an epoxy to a carbon fiber sheet or fabric. In these applications, among others, the use of the vacuum device 120, the sensor device 145, or the control device 155 can provide a similar benefit of increased uniformity (e.g., consistency, regularity) in a thickness of an applied coating as described herein.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to manufacture an electrode, comprising:
a slot die coating system to apply an electrode material to a current collector material at a coating opening; and
a vacuum device to apply a vacuum pressure at the coating opening, the vacuum pressure to control application of the electrode material to the current collector material.

2. The system of claim 1, comprising:
the current collector material to move in a first direction relative to the slot die coating system, the vacuum device to apply the vacuum pressure to pull the electrode material in a vacuum direction that is different from the first direction.

3. The system of claim 1, comprising:
a sensor device to provide a signal representative of a parameter regarding the electrode material applied to the current collector material; and
the vacuum device to apply the vacuum pressure based on the signal.

4. The system of claim 1, comprising:
a sensor device to provide a signal representative of a thickness of the electrode material applied to the current collector material; and
the vacuum device to apply the vacuum pressure based on the signal.

5. The system of claim 1, comprising:
a sensor device to provide a signal representative of a parameter regarding the electrode material applied to the current collector material; and
the vacuum device to apply the vacuum pressure based on a comparison of the signal with a threshold value.

6. The system of claim 1, comprising:
a sensor device to provide a signal representative of a parameter regarding the electrode material applied to the current collector material;
a control device communicably coupled with the sensor device and the vacuum device, the control device to determine, based on the signal, to operate the vacuum device; and
the vacuum device to apply the vacuum pressure based on a command from the control device.

7. The system of claim 1, comprising:
the vacuum device including a vacuum chamber, a valve, and a pump, the pump configured to create the vacuum pressure within the vacuum chamber with the valve in an open position.

8. The system of claim 1, comprising:
a sensor device to provide a signal representative of a parameter regarding the electrode material applied to the current collector material;
a control device communicably coupled with the sensor device and the vacuum device, the control device to determine, based on the signal, to operate the vacuum device; and
the vacuum device including a vacuum chamber, a valve, and a pump, the pump configured to create the vacuum pressure within the vacuum chamber with the valve in an open position, the valve to move from a closed position to the open position based on a command from the control device.

9. The system of claim 1, comprising:
the vacuum device including a plurality of vacuum chambers, a plurality of valves, and a pump, each of the plurality of vacuum chambers corresponding to one of the plurality of valves, the pump configured create the vacuum pressure within one or more of the plurality of vacuum chambers with the corresponding one or more valves in an open position.

10. The system of claim 1, comprising:
a sensor device including a plurality of sensors, each sensor associated with one of a plurality of portions of the electrode material applied to the current collector material, the sensor device to provide at least one signal representative of a parameter regarding the electrode material applied to the current collector material;
the vacuum device including a plurality of vacuum chambers, a plurality of valves, and a pump, each of the plurality of vacuum chambers associated with one of the plurality of portions of the electrode material and corresponding to one of the plurality of valves, the pump configured create the vacuum pressure within one or more of the plurality of vacuum chambers with the corresponding one or more valves in an open position; and
a control device communicably coupled with the sensor device and the vacuum device, the control device to determine, based on the at least one signal, to operate the vacuum device to apply the vacuum pressure via at least one vacuum chamber to one of the plurality of portions of the electrode material.

11. The system of claim 1, comprising:
a sensor device including a plurality of sensors, each sensor configured to measure a material thickness of one of a plurality of portions of the electrode material applied to the current collector material, the sensor device to provide at least one signal representative of a parameter regarding the electrode material applied to the current collector material;
the vacuum device including a plurality of vacuum chambers, a plurality of valves, and a pump, each of the plurality of vacuum chambers associated with one of the plurality of portions of the electrode material and corresponding to one of the plurality of valves, the pump configured create the vacuum pressure within one or more of the plurality of vacuum chambers with the corresponding one or more valves in an open position; and
a control device communicably coupled with the sensor device and the vacuum device, the control device to determine, based on the at least one signal, to operate the vacuum device to apply the vacuum pressure via at least one vacuum chamber to one of the plurality of portions of the electrode material.

12. The system of claim 1, comprising:
a sensor device including a plurality of sensors, each sensor configured to measure a material thickness of one of a plurality of portions of the electrode material applied to the current collector material, the sensor device to provide at least one signal representative of a parameter regarding the electrode material applied to the current collector material;
the vacuum device including a plurality of vacuum chambers, a plurality of valves, and a pump, each of the plurality of vacuum chambers associated with one of the plurality of portions of the electrode material and corresponding to one of the plurality of valves, the pump configured create the vacuum pressure within one or more of the plurality of vacuum chambers with the corresponding one or more valves in an open position; and
a control device communicably coupled with the sensor device and the vacuum device, the control device to operate, based on the at least one signal, the vacuum device to apply the vacuum pressure via at least one vacuum chamber to at least one portion of the electrode material, wherein the vacuum pressure applied via the at least one vacuum chamber causes the material thickness of the at least one portion of the electrode material to decrease.

13. The system of claim 1, comprising:
a sensor device including a plurality of sensors, each sensor configured to measure a material thickness of one of a plurality of portions of the electrode material applied to the current collector material, the sensor device to provide at least one signal representative of a parameter regarding the electrode material applied to the current collector material;
the vacuum device including a plurality of vacuum chambers, a plurality of valves, and a pump, each of the plurality of vacuum chambers associated with one of the plurality of portions of the electrode material and corresponding to one of the plurality of valves, the pump configured create the vacuum pressure within one or more of the plurality of vacuum chambers with the corresponding one or more valves in an open position; and
a control device communicably coupled with the sensor device and the vacuum device, the control device to operate, based on the at least one signal, the vacuum device to apply the vacuum pressure to one of the plurality of portions of the electrode material via at least one vacuum chamber, the control device to operate the vacuum device less than one second after receiving the at least one signal;
wherein the vacuum pressure applied via the at least one vacuum chamber causes the material thickness of the at least one portion of the electrode material to decrease.

14. The system of claim 1, comprising:
a sensor device including a plurality of sensors, each sensor configured to measure a material thickness of one of a plurality of portions of the electrode material applied to the current collector material, the sensor device to provide at least one signal representative of a parameter regarding the electrode material applied to the current collector material;
the vacuum device including a plurality of vacuum chambers, a plurality of valves, and a pump, each of the plurality of vacuum chambers associated with one of the plurality of portions of the electrode material and corresponding to one of the plurality of valves, the pump configured create the vacuum pressure within one or more of the plurality of vacuum chambers with the corresponding valve of the plurality of valves in an operating position between a closed position and a fully open position, wherein the vacuum pressure can vary according to the operating position; and
a control device communicably coupled with the sensor device and the vacuum device, the control device to operate, based on the at least one signal, the vacuum device to apply the vacuum pressure to one of the plurality of portions of the electrode material via at least one vacuum chamber by causing the corresponding valve of the plurality of valves to be in the operating position;
wherein the vacuum pressure applied via the at least one vacuum chamber causes the material thickness of the at least one portion of the electrode material to decrease.

15. A method, comprising:
applying, by a slot-die coating system, an electrode material to a current collector material; and
applying, by a vacuum device, a vacuum pressure to the applied electrode material to control application of the electrode material to the current collector material.

16. The method of claim 15, comprising:
measuring, via a sensor device, a thickness of the applied electrode material;
wherein operating the vacuum device to apply the vacuum pressure to the electrode material is based on the measured thickness of the applied electrode material.

17. The method of claim 15, comprising:
measuring, via a sensor device, a first thickness of the applied electrode material; and
altering, based on the first thickness of the applied electrode material, the vacuum pressure to control a second thickness of the applied electrode material.

18. The method of claim 15, comprising:
measuring, via a sensor device, a first thickness of the applied electrode material; and
altering, based on the first thickness of the applied electrode material, the vacuum pressure to control a second thickness of the applied electrode material;
wherein the vacuum pressure is altered less than one second after the first thickness is measured.

19. A control system, comprising:
a control device communicably coupled with a slot-die coating system, a valve associated with a vacuum chamber, and a sensor device, the control device configured to:
receive, from the sensor device, a signal representative of a thickness of a portion of an electrode material applied by the slot-die coating system to a current collector material; and
cause, based on the received signal, the valve to move from a closed position to an open position to apply, via the vacuum chamber, a vacuum pressure to the portion of the electrode material to control the thickness of the portion of the electrode material.

20. The control system of claim 19, comprising:
the control device coupled with a second valve associated with a second vacuum chamber, the control device configured to:
receive, from the sensor device, a second signal representative of a second thickness of a second portion of the electrode material applied by the slot-die coating system to the current collector material; and
cause, based on the received second signal, the second valve to move from a closed position to an open position to apply, via the second vacuum chamber, a second vacuum pressure to the second portion of the electrode material to control the second thickness of the second portion of the electrode material.
